(19) United States
(12) Patent Application Publication
(10) Pub. No.: US 2024/0214541 A1
(43) Pub. Date: Jun. 27, 2024

(54) IMAGE PICKUP APPARATUS, STEREOSCOPIC LENS APPARATUS, AND CONTROL METHOD

(71) Applicant: CANON KABUSHIKI KAISHA, Tokyo (JP)

(72) Inventor: HAJIME INOUE, Kanagawa (JP)

(21) Appl. No.: 18/539,761

(22) Filed: Dec. 14, 2023

(30) Foreign Application Priority Data
Dec. 23, 2022 (JP) 2022-206350
Mar. 24, 2023 (JP) 2023-048980

(51) Int. Cl. H04N 13/218; H04N 23/67

(52) U.S. Cl. CPC H04N 13/218; H04N 23/67

(57) ABSTRACT

An image pickup apparatus is attachable to, detachable from, and communicable with a stereoscopic lens apparatus that includes two optical systems arranged in parallel, a focusing unit configured to perform focusing that integrally moves the two optical systems, and a focus difference adjustment unit configured to perform focus difference adjustment for adjusting a focus difference between the two optical systems by independently moving one optical system of the two optical systems. The image pickup apparatus includes a memory storing instructions, and a processor configured to execute the instructions to detect an attachment of the stereoscopic lens apparatus to the image pickup apparatus, and provide a notification prompting a user to perform the focus difference adjustment with the stereoscopic lens apparatus attached to the image pickup apparatus.

### BACKGROUND

### Technical Field

One of the aspects of the embodiments relates to an image pickup apparatus and a stereoscopic lens apparatus which are suitable for capturing a stereoscopic image which can be viewed stereoscopically.

### Description of Related Art

A stereoscopic lens apparatus that enables an acquisition of a stereoscopic image by image capturing is used, in which two optical systems are arranged in parallel so that they have parallax with respect to each other. Japanese Patent Laid-Open No. 2021-51282 discloses a stereoscopic lens apparatus in which two optical systems (fisheye lenses) are arranged in parallel and two reflective elements are placed in each optical system to bend an optical path. By bending the optical path, a distance between image-side lens units in the two optical systems can be narrowed while a baseline length between object-side lens units in the two optical systems can be maintained, so that image circles of the two optical systems can be formed on a single image sensor in an image pickup apparatus with an interchangeable lens.

In the stereoscopic lens apparatus disclosed in Japanese Patent Laid-Open No. 2021-51282, an inclination amount and inclination direction of the image sensor differ for each image pickup apparatus to which the lens apparatus is attached due to manufacturing errors. For this reason, it is necessary to adjust (correct) a difference in focus (focus difference) between the two optical systems for each image pickup apparatus. However, there is a risk that a user may not notice an existence of the focus difference between the two optical systems.

### SUMMARY

An image pickup apparatus according to one aspect of the embodiment is attachable to, detachable from, and communicable with a stereoscopic lens apparatus that includes two optical systems arranged in parallel, a focusing unit configured to perform focusing that integrally moves the two optical systems, and a focus difference adjustment unit configured to perform focus difference adjustment for adjusting a focus difference between the two optical systems by independently moving one optical system of the two optical systems. The image pickup apparatus includes a memory storing instructions, and a processor configured to execute the instructions to detect an attachment of the stereoscopic lens apparatus to the image pickup apparatus, and provide a notification prompting a user to perform the focus difference adjustment with the stereoscopic lens apparatus attached to the image pickup apparatus.

A stereoscopic lens apparatus according to another aspect of the embodiment is attachable to, detachable from, and communicable with an image pickup apparatus. The stereoscopic lens apparatus includes two optical systems arranged in parallel, a focusing unit configured to perform focusing that integrally moves the two optical systems, a focus difference adjustment unit configured to perform focus difference adjustment for adjusting a focus difference between the two optical systems by independently moving one optical system of the two optical systems, a memory storing instructions, and a processor configured to execute the instructions to detect an attachment of the stereoscopic lens apparatus to the image pickup apparatus, and transmit to the image pickup apparatus information indicating that the focus difference adjustment can be performed in a case where the stereoscopic lens apparatus is attached to the image pickup apparatus capable of providing a notification prompting a user to perform the focus difference adjustment.

A control method corresponding to each of the above image pickup apparatus and the above stereoscopic lens apparatus also constitutes another aspect of the embodiment. A storage medium storing a program that causes a computer to execute the above control method also constitutes another aspect of the embodiment.

Further features of the disclosure will become apparent from the following description of embodiments with reference to the attached drawings.

### BRIEF DESCRIPTION OF THE DRAWINGS

FIG. 1 illustrates a configuration of a stereoscopic camera system including an interchangeable lens and a camera according to a first embodiment.

FIG. 2 illustrates a configuration of a camera control unit and a lens control unit according to the first embodiment.

FIGS. 3A and 3B schematically illustrate a relative focus difference according to the first embodiment.

FIGS. 4A and 4B are flowcharts illustrating notification processing according to the first embodiment.

FIGS. 5A and 5B are flowcharts illustrating notification processing according to a second embodiment.

FIGS. 6A and 6B are flowcharts which illustrate notification processing according to a third embodiment.

FIGS. 7A and 7B are flowcharts illustrating notification processing according to a fourth embodiment.

FIGS. 8A and 8B are flowcharts illustrating focus difference adjustment processing according to a fifth embodiment.

FIGS. 9A and 9B are flowcharts which illustrate focus difference adjustment processing according to a sixth embodiment.

FIG. 10 illustrates a configuration of a stereoscopic camera system including an interchangeable lens and a camera according to a seventh embodiment.

FIG. 11 illustrates a configuration of a camera control unit and a lens control unit according to the seventh embodiment.

FIGS. 12A and 12B are flowcharts illustrating notification processing according to the seventh embodiment.

FIGS. 13A and 13B are flowcharts illustrating notification processing according to an eighth embodiment.

FIGS. 14A and 14B are flowcharts illustrating notification processing according to a ninth embodiment.

FIGS. 15A and 15B are flowcharts illustrating notification processing according to a tenth embodiment.

FIGS. 16A and 16B are flowcharts illustrating focus difference adjustment processing according to a eleventh embodiment.

FIGS. 17A and 17B are flowcharts illustrating focus difference adjustment processing according to a twelfth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### FIRST EMBODIMENT

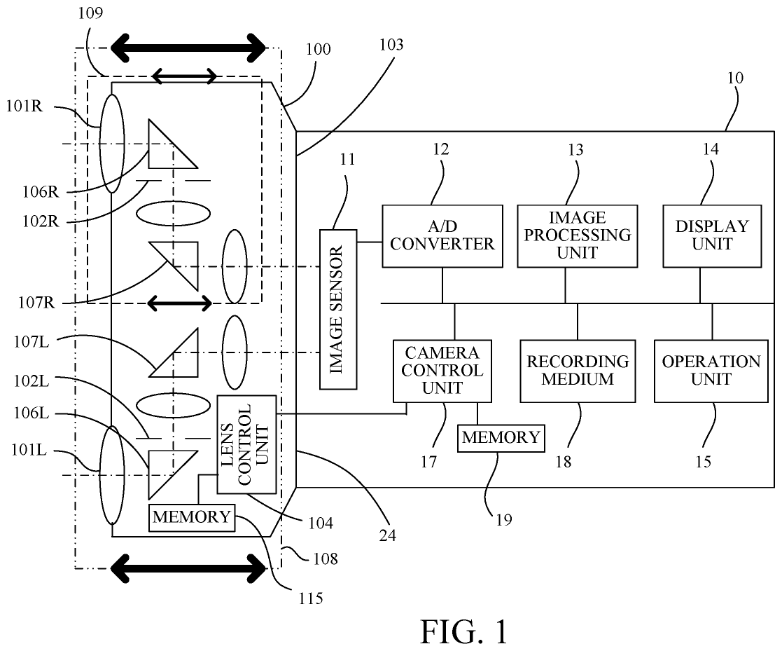

FIG. 1 illustrates a configuration of a stereoscopic camera system in which an interchangeable lens 100 as a stereoscopic lens apparatus according to the first embodiment is detachably attached to a camera 10 as an image pickup apparatus. The camera 10 and the interchangeable lens 100 each have a camera mount 24 and a lens mount 103, which are provided with electrical contacts for supplying a power from the camera 10 to the interchangeable lens 100 and enabling mutual communication. The camera 10 has an image sensor 11 that outputs an electrical signal by photoelectrically converting an object image formed by two optical systems which are arranged in parallel in the interchangeable lens 100, namely a right eye lens unit 101R and a left eye lens unit 101L.

The camera 10 also has an A/D converter 12 that converts an analog electrical signal output from the image sensor 11 into a digital signal, and an image processing unit 13 that generates an image by performing various image processing on the digital signal. The image generated by the image processing unit 13 is displayed on a display unit 14 and recorded on a recording medium 18.

In addition, the camera 10 has an operation unit (operation unit) 15 that includes a power switch for turning the power on and off, an image pickup switch for starting image capturing (image recording), and a selection/setting switch for setting various menu items. A camera control unit 17 serving as a camera control unit controls the image processing unit 13 and communication with the interchangeable lens 100 in response to a signal from the operation unit 15.

In the interchangeable lens 100, the right lens unit 101R and the left eye lens unit 101L each include prisms 106R, 107R, 106L, and 107L, which transform a direction of an optical axis by 90 degrees by reflection, and a right diaphragm unit 102R and a left diaphragm unit 102L. By using the prisms 106R, 107R, 106L, and 107L, a distance between the optical axes on an image side of the right eye lens unit 101R and the left eye lens unit 101L can be made shorter than a distance between the optical axes on an object side of the right eye lens unit 101R and the left eye lens unit 101L (a baseline length). Thereby, image circles formed by the right eye lens unit 101R and the left eye lens unit 101L can be formed on the single image sensor 11 of the camera 10, so that two images that can be stereoscopically viewed with parallax to each other can be acquired through the image sensor 11.

The interchangeable lens 100 also includes a lens control unit 104 as a lens control unit that controls the diaphragm units 102R and 102L in accordance with a control signal received from the camera control unit 17 through communication.

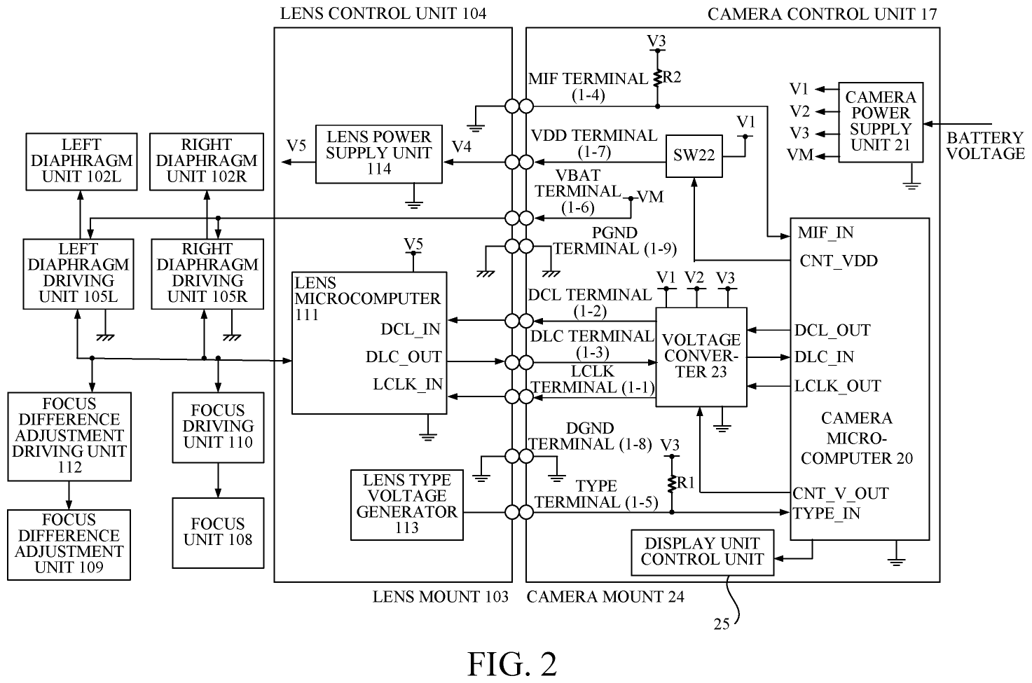

FIG. 2 illustrates an internal configuration of the camera control unit 17 and the lens control unit 104, and a configuration of a diaphragm and focus drive system provided in the interchangeable lens 100. The camera control unit 17 and the lens control unit 104 are electrically connected via terminals provided on the camera mount 24 and the lens mount 103.

An LCLK terminal (1-1) is a terminal for a communication clock signal output from the camera 10 to the interchangeable lens 100. A DCL terminal (1-2) is a terminal for communication data output from the camera 10 to the interchangeable lens 100. A DLC terminal (1-3) is a terminal for communication data output from the interchangeable lens 100 to the camera 10.

An MIF terminal (1-4) is a terminal for detecting that the interchangeable lens 100 has been attached to the camera 10. A camera microcomputer 20, which is a microcomputer in the camera control unit 17, detects that the interchangeable lens 100 has been attached to the camera 10 based on a voltage of the MIF terminal.

A TYPE terminal (1-5) is a terminal for detecting a type of the interchangeable lens 100 that has been attached to the camera 10. The camera microcomputer 20 detects the type of the interchangeable lens 100 that has been attached to the camera 10 based on a voltage of the TYPE terminal. The voltage of the TYPE terminal is generated by a lens type voltage generator 113 in the lens control unit 104.

A VBAT terminal (1-6) is a terminal for supplying a drive power (VM) used for various operations other than a communication control from the camera 10 to the interchangeable lens 100. A VDD terminal (1-7) is a terminal that supplies a communication control power (VDD) used for the communication control from the camera 10 to the interchangeable lens 100. A DGND terminal (1-8) is a terminal that connects a communication control system of the camera 10 and the interchangeable lens 100 to the ground. A PGND terminal (1-9) is a terminal for connecting a mechanical drive system including a motor and the like provided in the camera 10 and the interchangeable lens 100 to the ground.

A plurality of types of interchangeable lenses 100 having different communication voltages with the camera 10 are selectively attached to the camera 10 according to this embodiment. In the following description, the case is discussed where there are two types of interchangeable lenses 100 that the camera 10 identifies based on the voltage of the TYPE terminal: a first interchangeable lens and a second interchangeable lens whose communication voltage is different from that of the first interchangeable lens.

A camera power supply unit 21 provided in the camera control unit 17 converts a battery voltage supplied from a battery (not illustrated) mounted on the camera 10 into a voltage necessary for an operation of each circuit. In this case, the power supply unit 21 generates voltages V1, V2, V3, and VM.

The first voltage V1 is a power supply voltage as the communication control power (VDD) for the first and second interchangeable lenses, and is also a communication voltage for the first interchangeable lens. The second voltage V2 is a communication voltage of the second interchangeable lens. The third voltage V3 is a power supply voltage for operating the camera microcomputer 20. The VM is a power supply voltage for driving the first and second interchangeable lenses.

When a power switch 22 is turned on, the camera microcomputer 20 starts supplying the VDD and the VM from the camera 10 to the interchangeable lens 100.

When the power switch 22 is turned off, the camera microcomputer 20 stops supplying the VDD and the VM from the camera 10 to the interchangeable lens 100.

The camera microcomputer 20 communicates with the interchangeable lens 100 via a voltage converter 23. The camera microcomputer 20 has an LCLK_OUT terminal that outputs a communication clock signal, a DCL_OUT terminal that outputs communication data to the interchangeable lens, and a DLC_IN terminal that receives an input of communication data from the interchangeable lens. The communication clock signal and communication data correspond to a signal for communication.

The camera microcomputer 20 also has an MIF_IN terminal for detecting an attachment of the interchangeable lens 100, a TYPE_IN terminal for identifying the type of the interchangeable lens 100, and a CNT_V_OUT terminal that outputs a communication voltage switching signal to the voltage converter 23.

In addition, the camera microcomputer 20 has a CNT_VDD_OUT terminal that outputs an energization signal for the power switch 22, a connection terminal with the image processing unit 13, and a connection terminal with the operation unit 15. Further, the camera microcomputer 20 controls an operation of the display unit 14 via a display unit control unit 25.

A lens microcomputer 111, which is a microcomputer in the lens control unit 104, communicates with the camera microcomputer 20 via the voltage converter 23 described above. The lens microcomputer 111 has an LCLK_IN terminal that receives an input of a communication clock signal, a DLC_OUT terminal that outputs communication data to the camera 10, and a DCL_IN terminal that receives an input of communication data from the camera 10. The lens microcomputer 111 also has a connection terminal with diaphragm driving units 105R/105L, a focus driving unit 110, and a focus difference adjustment driving unit 112. Further, the lens control unit 104 has a lens power supply unit 114.

A detection of an attachment of the interchangeable lens 100 to the camera 10 will be described. Since the MIF_IN terminal of the camera microcomputer 20 is pulled up to the power supply by a resistor R2 (100KΩ), its voltage value becomes H (High) when a lens is not attached. However, the MIF_IN terminal is connected to the GND in the interchangeable lens 100 when the interchangeable lens (first and second interchangeable lenses) 100 is attached, so regardless of the type of the interchangeable lens 100, its voltage value becomes L (Low) when the interchangeable lens 100 is attached.

On the other hand, the interchangeable lens 100 includes the diaphragm driving units 105R and 105L that drive actuators that operate the diaphragm units 102R and 102L. Further, in the interchangeable lens 100, the right eye and left eye lens units 101R and 101L are held by a focus unit 108. By moving the focus unit 108 in an optical axis direction by the focus driving unit 110, focusing is performed using an entire extension method in which the entire right eye and left eye lens units 101R and 101L are integrally moved in the optical axis direction. The focus unit 108 and the focus driving unit 110 constitute a focusing unit.

Furthermore, the interchangeable lens 100 includes a focus difference adjustment unit 109 and the focus difference adjustment driving unit 112 for electrically adjusting a relative focus difference. The focus difference adjustment unit 109 and the focus difference adjustment driving unit 112 constitute a focus difference adjustment unit.

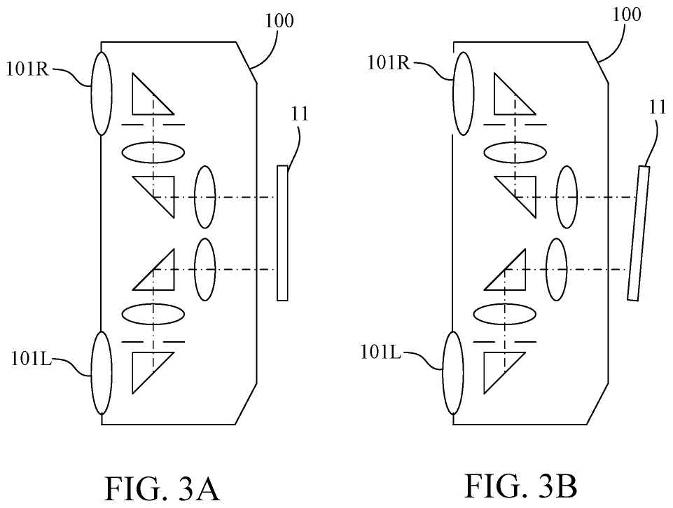

FIGS. 3A and 3B schematically show the relative focus difference, which is the focus difference between the right eye and left eye lens units 101R and 101L. In the interchangeable lens 100 according to this embodiment, the relative focus difference may occur between the right eye and left eye lens units 101R and 101L due to variations in an inclination direction and inclination amount of the image sensor 11 caused by individual differences in the camera 10, or due to reliability deterioration caused by temperature, humidity, and impact, etc. FIG. 3A illustrates an ideal case in which the image sensor 11 is not inclined. FIG. 3B illustrates a case where the image sensor 11 is inclined. In a case of FIG. 3B, even if the right eye and left eye lens units 101R and 101L are moved together, they cannot be focused simultaneously. In other words, the relative focus difference as a shift in a focus state occurs between the right eye and left eye lens units 101R and 101L.

For this reason, the interchangeable lens 100 according to this embodiment has a focus difference adjustment mechanism (focus difference adjustment unit 109 and focus difference adjustment driving unit 112) for a user to adjust (correct) the relative focus difference between the right eye lens unit 101R and left eye lens unit 101L. In the focus difference adjustment mechanism, an eccentric colo connected via a screw to the focus difference adjustment unit 109 that holds the right eye lens unit 101R is rotationally driven by a motor of the focus difference adjustment driving unit 112. Thereby, without moving the left eye lens unit 101L in the optical axis direction, the right eye lens unit 101R can be moved independently in the optical axis direction to perform focusing, that is, an adjustment of the relative focus difference.

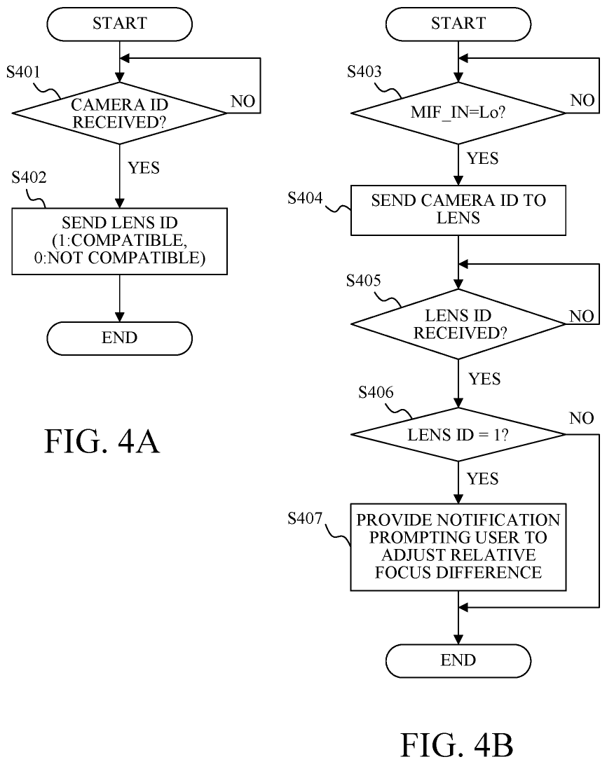

Flowcharts in FIGS. 4A and 4B show processing (control method) executed in this embodiment. FIG. 4A illustrates processing executed by the lens control unit 104 (the lens microcomputer 111) in accordance with a program, and FIG. 4B illustrates processing executed by the camera control unit 17 (the camera microcomputer 20) in accordance with a program.

When the interchangeable lens 100 is attached to the camera 10, in a step S401 of FIG. 4A the lens control unit 104 serving as attachment detector on the lens side checks whether or not a camera ID has been received from the camera control unit 17 (whether or not the interchangeable lens 100 has been attached to the camera 10). At this time, the lens control unit 104 checks from the camera ID whether or not the camera 10 has a function to perform a notification described below.

The lens control unit 104 that has received the camera ID proceeds to a step S402, and sends to the camera control unit 17 a lens ID that indicates whether or not the interchangeable lens 100 is a stereoscopic lens apparatus having the focus unit 108 including the focus difference adjustment mechanism. The lens ID=1 indicates that the attached interchangeable lens is a stereoscopic lens apparatus having the focus unit 108 including the focus difference adjustment mechanism (in other words, the focusing can be performed by independently moving the right eye lens unit 101R). The lens ID=0 indicates that the attached interchangeable lens is not a stereoscopic lens apparatus having the focus unit 108 including the focus difference adjustment mechanism. Then, this processing ends.

On the other hand, when the interchangeable lens 100 is attached to the camera 10, in a step S403 of FIG. 4B, the camera control unit 17 serving as attachment detector on the camera side determines whether or not MIF_IN=Lo, that is, whether or not the interchangeable lens 100 has been attached to the camera 10. In a case of MIF_IN≠Lo, the camera control unit 17 repeats the determination in the step S403, and in a case of MIF_IN =Lo, the camera control unit 17 sends the camera ID to the lens control unit 104 in a step S404, and proceeds to a step S405.

In the step S405, the camera control unit 17 determines whether or not the lens ID has been received. The camera control unit 17 repeats the determination in the step S405 in a case where the lens ID has not been received, and proceeds to a step S406 in a case where the lens ID has been received.

In the step S406, the camera control unit 17 determines whether or not the lens ID=1. The camera control unit 17 ends this processing in a case where the lens ID=0, and proceeds to a step S407 in a case where the lens ID=1.

In the step S407, the camera control unit 17 performs the notification prompting the user to adjust the relative focus difference. Specifically, a message or an icon prompting the adjustment of the relative focus difference is displayed on the display unit 14 through the display unit control unit 25. The message is, for example, “Please perform the focusing of the right eye lens.” The notification prompting the user to adjust the relative focus difference may be made by sound from a speaker (not illustrated). Then, this processing ends.

According to this embodiment, the user can be prompted to adjust the relative focus difference in response to the interchangeable lens 100 being attached to the camera 10.

### SECOND EMBODIMENT

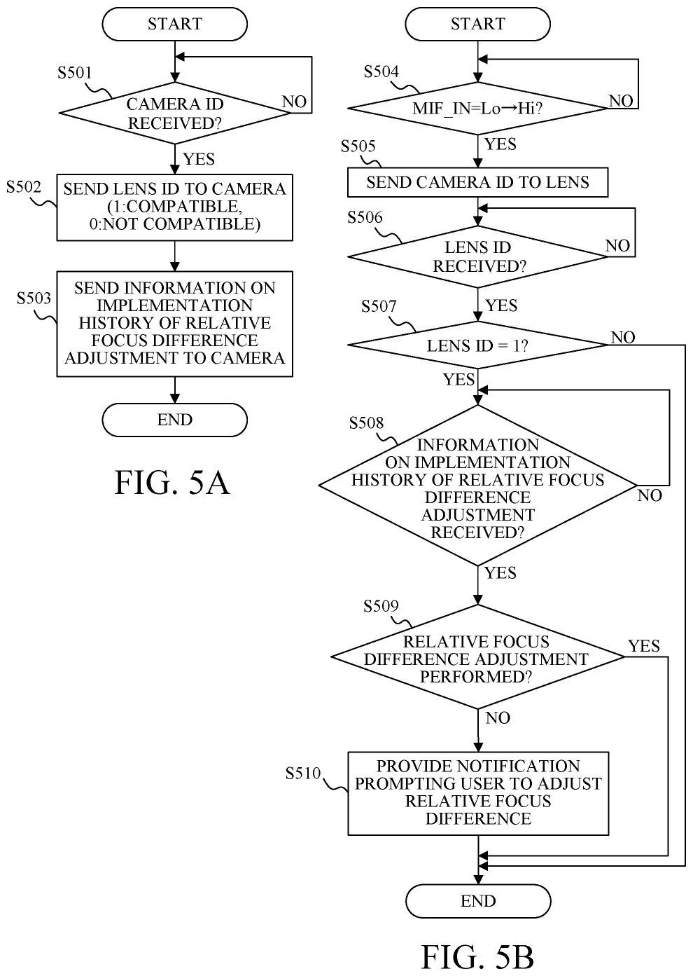

In the second embodiment, only when an adjustment of the relative focus difference has not been performed in the past when the interchangeable lens 100 was attached to the camera 10 in the past, the notification prompting the user to adjust the relative focus difference is provided. Flowcharts in FIGS. 5A and 5B show processing executed in this embodiment. FIG. 5A illustrates processing executed by the lens control unit 104 (the lens microcomputer 111) in accordance with a program, and FIG. 5B illustrates processing executed by the camera control unit 17 (the camera microcomputer 20) in accordance with a program.

When the interchangeable lens 100 is attached to the camera 10, the lens control unit 104 performs processes of steps S501 and S502 in FIG. 5A. The processes of the step S501 and the step S502 are the same as the processes of the step S401 and the step S402 in FIG. 4A.

In a step S503 after the step S502, the lens control unit 104 sends to the camera control unit 17 information on an implementation history of the adjustment of the relative focus difference in an attachment of the interchangeable lens 100 to the camera 10 in the past. Then, this processing ends.

On the other hand, when the interchangeable lens 100 is attached to the camera 10, the camera control unit 17 performs processes from a step S504 to a step S507 in FIG. 5B. The processes of these steps S504 to S507 are the same as processes of the steps S403 to S406 in FIG. 4B.

In a case where the lens ID=1 in the step S507, the camera control unit 17 determines whether or not the information on the implementation history of the adjustment of the relative focus difference has been received from the lens control unit 104 in a step S508. The camera control unit 17 repeats the determination in the step S508 in a case where the information on the implementation history has not been received, and proceeds to a step S509 in a case where the information on the implementation history has been received.

In the step S509, the camera control unit 17 determines whether or not the information on the implementation history of the adjustment of the relative focus difference received in the step S508 indicates that the adjustment of the relative focus difference has been performed, that is, whether or not the adjustment of the relative focus difference has been performed in the past for the currently attached interchangeable lens 100. In a case where the adjustment of the relative focus difference has not been performed (i.e., “no”), the flow proceeds to a step S510, and in a case where the adjustment of the relative focus difference has been performed (i.e., “yes”), this processing ends.

In the step S510, the camera control unit 17 performs the notification (display) prompting the user to adjust the relative focus difference, similarly to the step S407 in FIG. 4B. Then, this processing ends.

In this embodiment, the user can be prompted to adjust the relative focus difference in a combination of the interchangeable lens 100 and the camera 10 for which the adjustment of the relative focus difference has not been performed in the past.

### THIRD EMBODIMENT

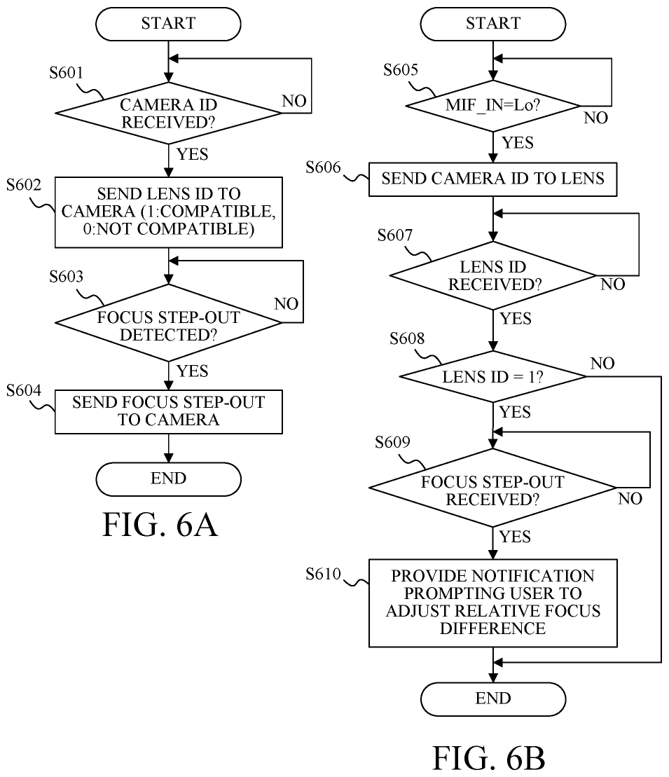

In the third embodiment, when an external force is applied to at least one of the right eye and left eye lens units 101R and 101L (the focus unit 108 or the focus difference adjustment unit 109), the notification prompting the user to adjust the relative focus difference is provided. Flowcharts in FIGS. 6A and 6B show processing executed in this embodiment. FIG. 6A illustrates processing executed by the lens control unit 104 (the lens microcomputer 111) in accordance with a program, and FIG. 6B illustrates processing executed by the camera control unit 17 (the camera microcomputer 20) in accordance with a program. In this embodiment, in response to detection of step-out of a stepping motor of the focus driving unit 110 or a stepping motor of the focus difference adjustment driving unit 112 due to an action of an external force, the notification prompting the user to adjust the relative focus difference is performed.

When the interchangeable lens 100 is attached to the camera 10, the lens control unit 104 performs processes of steps S601 and S602 in FIG. 6A. The processes of the step S601 and the step S602 are the same as the processes of the step S401 and the step S402 in FIG. 4A.

In a step S603 after the step S602, the lens control unit 104 determines whether or not the step-out has occurred in the stepping motor of the focus driving unit 110 or the stepping motor of the focus difference adjustment driving unit 112. Specifically, light-shielding blades are attached to a rotary shaft of each stepping motor, and the light-shielding blades and photo interrupters are used to detect whether or not each stepping motor rotates at a timing other than during focusing using the entire extension method or during the adjustment of the relative focus difference. By detecting a rotation of each stepping motor, it is possible to determine that the step-out has occurred, in other words, that the focus unit 108 or the focus difference adjustment unit 109 has received the external force. External force detector is constituted by the light-shielding blades and the photo interrupters.

Instead of the light-shielding blades and the photo interrupters, an external force sensor that can directly detect an action of an external force may be used, and in a case where the action of the external force of a predetermined magnitude or more is detected, it may be assumed that the step-out has occurred in the stepping motor. In a case where the lens control unit 104 does not determine that the step-out (hereinafter referred to as focus step-out) has occurred in the stepping motor of the focus driving unit 110 or the focus difference adjustment driving unit 112, the lens control unit 104 repeats the process of the step S603. In a case where the lens control unit 104 determines that the focus step-out has occurred in the stepping motor of the focus driving unit 110 or the focus difference adjustment driving unit 112, the lens control unit 104 proceeds to a step S604.

In the step S604, the lens control unit 104 sends to the camera control unit 17 that the focus step-out has occurred. Then, this processing ends.

On the other hand, when the interchangeable lens 100 is attached to the camera 10, the camera control unit 17 performs processes form steps S605 to S608 in FIG. 6B. The processes from the steps S605 to S608 are the same as the processes from the steps S403 to S406 in FIG. 4B.

In a case where the lens ID=1 in the step S608, the camera control unit 17 determines whether or not the occurrence of the focus step-out has been received from the lens control unit 104 in a step S609. In a case where the camera control unit 17 has not received the occurrence of the focus step-out, the camera control unit 17 repeats the process of the step S608, and in a case where the camera control unit 17 has received it, the camera control unit 17 proceeds to a step S610.

In the step S610, the camera control unit 17 performs the notification (display) prompting the user to adjust the relative focus difference, similar to the step S407 in FIG. 4B. Then, this processing ends.

In this embodiment, in a case where the relative focus difference occurs due to an action of an external force, the user can be prompted to adjust the relative focus difference.

### FOURTH EMBODIMENT

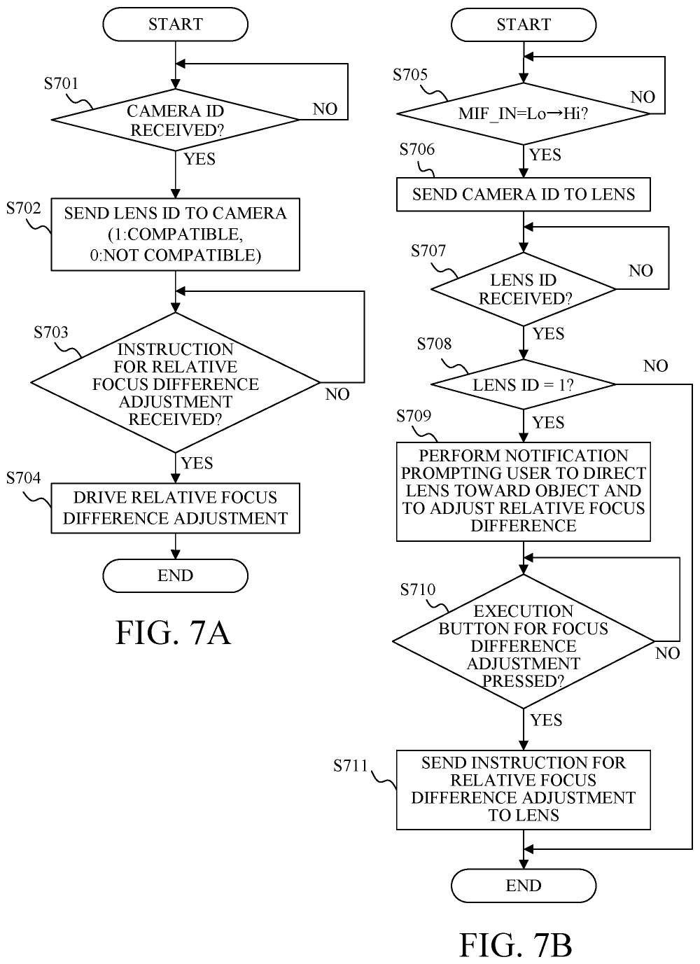

In the fourth embodiment, the notification is provided to prompt the user to point the interchangeable lens 100 at an object and then adjust the relative focus difference. Flowcharts in FIGS. 7A and 7B show processing executed in this embodiment. FIG. 7A illustrates processing executed by the lens control unit 104 (the lens microcomputer 111) in accordance with a program, and FIG. 7B illustrates processing executed by the camera control unit 17 (the camera microcomputer 20) in accordance with a program.

When the interchangeable lens 100 is attached to the camera 10, the lens control unit 104 performs processes of steps S701 and S702 in FIG. 7A. The processes in the step S701 and the step S702 are the same as the processes in the step S401 and the step S402 in FIG. 4A.

In a step S703 after the step S702, the lens control unit 104 determines whether or not an instruction for the adjustment of the relative focus difference has been received from the camera control unit 17. The instruction for the adjustment of the relative focus difference is sent from the camera control unit 17 to the lens control unit 104 when the user operates an execution button (not illustrated) for the adjustment of the focus difference provided on the operation unit 15 of the camera 10. The execution button for the adjustment of the focus difference may be a physical button or may be provided on a touch panel of the display unit 14. In a case where the lens control unit 104 has not received the instruction, the lens control unit 104 repeats the determination in the step S703, and in a case where the lens control unit 104 has received the instruction, the lens control unit 104 proceeds to a step S704.

In the step S704, the lens control unit 104 drives the focus difference adjustment driving unit 112 to perform the adjustment of the relative focus difference. Then, this processing ends.

On the other hand, when the interchangeable lens 100 is attached to the camera 10, the camera control unit 17 performs processes from steps S705 to S708 in FIG. 7B. The processes from the steps S705 to S708 are the same as the processes from the steps S403 to S406 in FIG. 4B.

In a case where the lens ID=1 in the step S708, the camera control unit 17 performs the notification (display) in a step S709 prompting the user to point the interchangeable lens 100 at the object and perform the adjustment of the relative focus difference. Specifically, a message or an icon is displayed on the display unit 14 of the camera 10 to prompt the user to point the interchangeable lens 100 at the object and adjust the relative focus difference. The message may be, “Please point the lens at the object and press the button for the adjustment of the focus difference.”

Next, in a step S710, the camera control unit 17 determines whether or not the user has operated the execution button for the adjustment of the focus difference. In a case where the execution button for the adjustment of the focus difference has not been operated, the determination in the step S710 is repeated, and in a case where the execution button for the adjustment of the focus difference has been operated, the camera control unit 17 proceeds to a step S711.

In the step S711, the camera control unit 17 sends the instruction for the adjustment of the relative focus difference to the lens control unit 104. Then, this processing ends.

According to this embodiment, not only can the user be prompted to adjust the relative focus difference, but also it is possible to notify the user that the interchangeable lens 100 needs to be directed toward the object when adjusting the relative focus difference. This makes it possible to reliably adjust the relative focus difference for the object.

### FIFTH EMBODIMENT

In the fifth embodiment, a case is described in which the camera 10 is capable of storing an adjustment amount (hereinafter referred to as focus difference adjustment amount) as information about the adjustment of the relative focus difference (focusing) for each individual interchangeable lens 100. The focus difference adjustment amount is a drive amount of the focus difference adjustment driving unit 112. In this embodiment, when the interchangeable lens 100 with the focus difference adjustment amount stored in the camera 10 is attached to the camera 10, the adjustment of the relative focus difference using the stored focus difference adjustment amount is performed by the interchangeable lens 100.

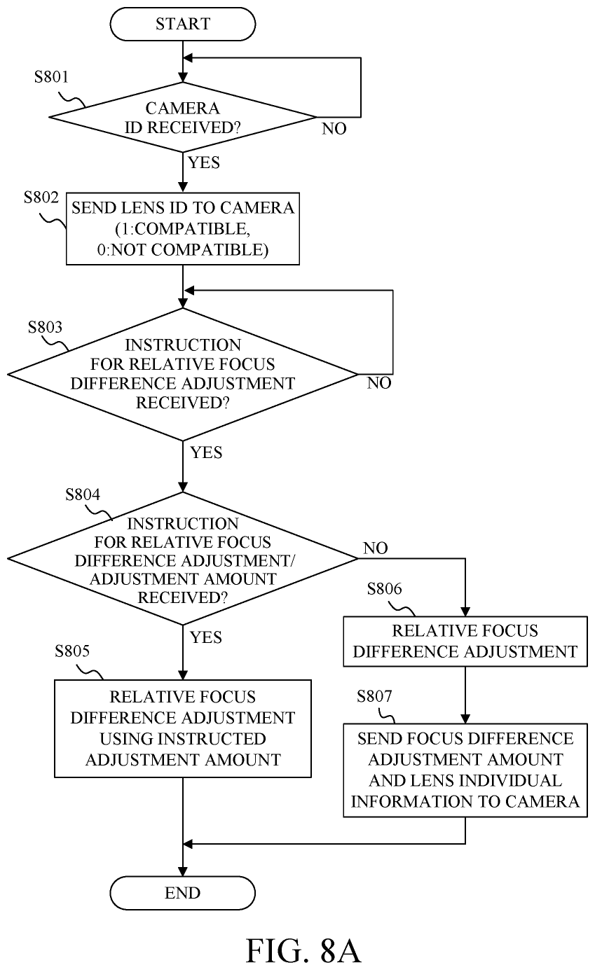

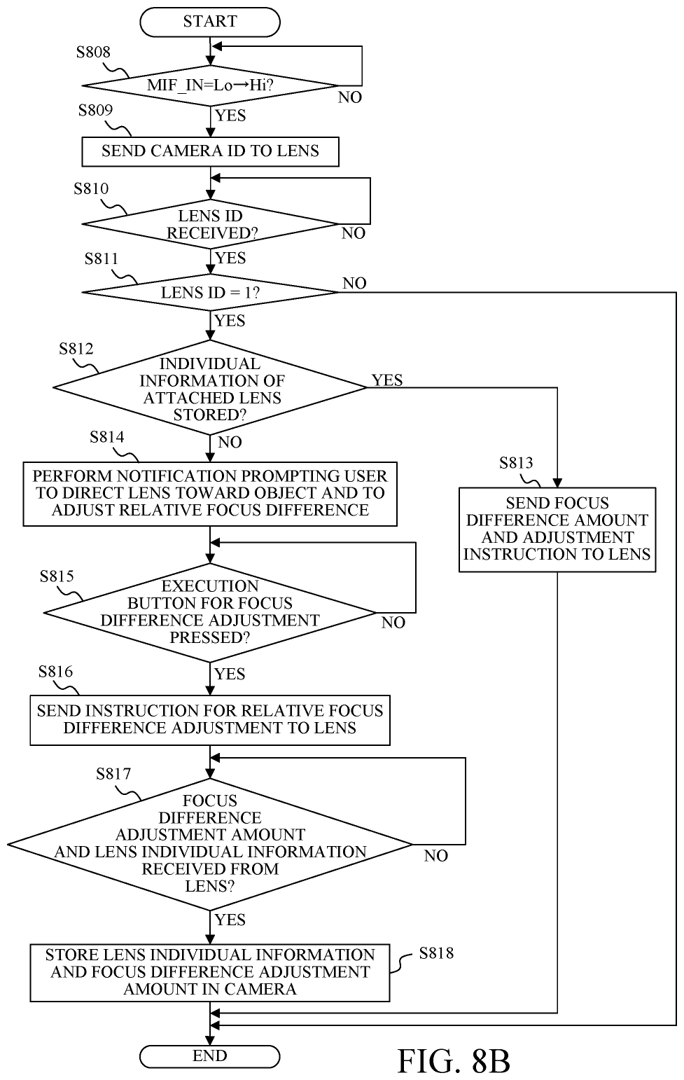

Flowcharts in FIGS. 8A and 8B show processing executed in this embodiment. FIG. 8A illustrates processing executed by the lens control unit 104 (the lens microcomputer 111) in accordance with a program, and FIG. 8B illustrates processing executed by the camera control unit 17 (the camera microcomputer 20) in accordance with a program.

When the interchangeable lens 100 is attached to the camera 10, the lens control unit 104 performs processes from steps S801 to S803 in FIG. 8A. The processes from the steps S801 to S803 are the same as the processes from steps S701 to S703 in FIG. 7A.

The lens control unit 104, which has received the instruction of the adjustment of the relative focus difference in the step S803, determines whether or not the lens control unit 104 has received the focus difference adjustment amount from the camera control unit 17 in a step S804. In a case where the lens control unit 104 has received the focus difference adjustment amount, the lens control unit 104 proceeds to a step S805, and in a case where the lens control unit 104 has not received the focus difference adjustment amount, the lens control unit 104 proceeds to a step S806.

In the step S805, the lens control unit 104 uses the instructed focus difference adjustment amount to drive the focus difference adjustment driving unit 112 to perform the adjustment of the relative focus difference. Then, this processing ends.

Further, in the step S806, the lens control unit 104 drives the focus difference adjustment driving unit 112 to perform the adjustment of the relative focus difference.

Next, in a step S807, the lens control unit 104 sends the focus difference adjustment amount in the step S806 to the camera control unit 17 together with individual information (manufacturing number, serial number, etc.) of the interchangeable lens 100. Then, this processing ends. The camera control unit 17 stores (saves) the focus difference adjustment amount in a memory (storage unit) 19 in the camera 10 in association with the received individual information about the interchangeable lens 100, as will be described later.

On the other hand, when the interchangeable lens 100 is attached to the camera 10, the camera control unit 17 performs processes from steps S808 to S811 in FIG. 8B. The processes from the steps S808 to S811 are the same as the processes from the steps S705 to S708 in FIG. 7B.

In a case where the lens ID=1 in the step S811, the camera control unit 17 determines in a step S812 whether or not the individual information about the attached interchangeable lens 100 has been stored in the memory 19 in the camera 10. In a case where the individual information has been stored, the camera control unit 17 proceeds to a step S813. In a case where the individual information has not been stored, the camera control unit 17 proceeds to a step S814.

In the step S813, the camera control unit 17 sends to the lens control unit 104 the focus difference adjustment amount stored in association with the stored individual information about the interchangeable lens 100.

The processes from the steps S814 to S816 are the same as the processes from the steps S709 to S711 in FIG. 7B.

In a step S817 after the step S816, the camera control unit 17 determines whether or not the individual information about the interchangeable lens 100 and the focus difference adjustment amount have been received from the lens control unit 104. In a case where these have not been received, the camera control unit 17 repeats the determination in the step S817. In a case where these have been received, the camera control unit 17 proceeds to a step S818.

In the step S818, the camera control unit 17 stores the focus difference adjustment amount in the memory 19 in the camera 10 in association with the received individual information about the interchangeable lens 100. Then, this processing ends.

In this embodiment, in a case where the adjustment of the relative focus difference has been performed in the past for a combination of the camera 10 and the interchangeable lens 100, when using the combination again, the focus difference adjustment amount stored in the camera 10 is used to quickly adjust the relative focus difference.

### SIXTH EMBODIMENT

In the sixth embodiment, a case is described in which the interchangeable lens 100 is capable of storing the focus difference adjustment amount for each individual camera 10. In this embodiment, in a case where the focus difference adjustment amount for the camera 10 to which the interchangeable lens 100 is attached is stored in the interchangeable lens 100, the adjustment of the relative focus difference using the stored focus difference adjustment amount is performed by the interchangeable lens 100.

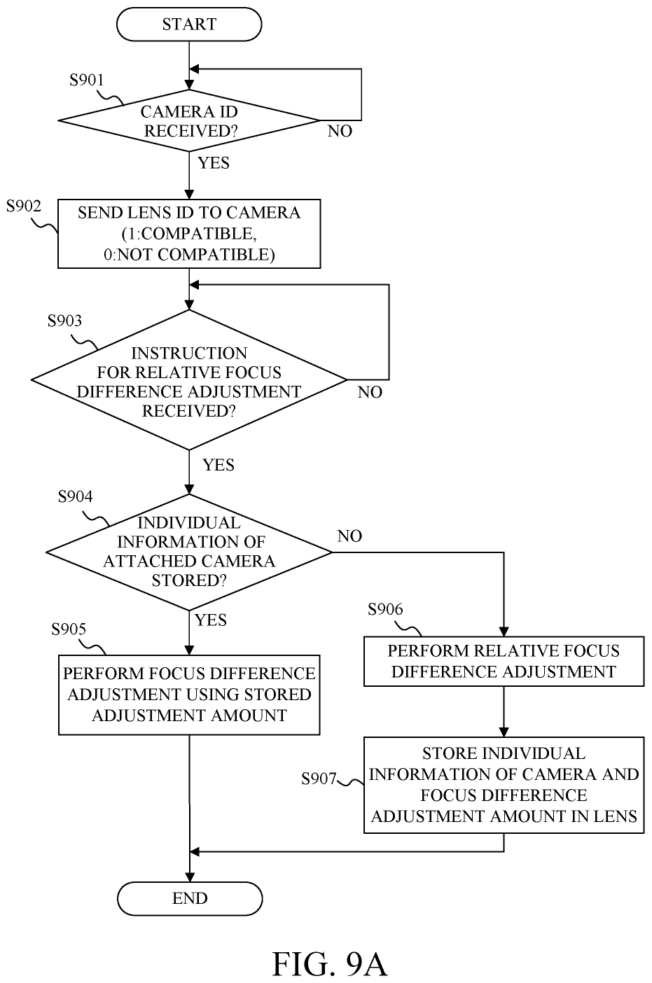

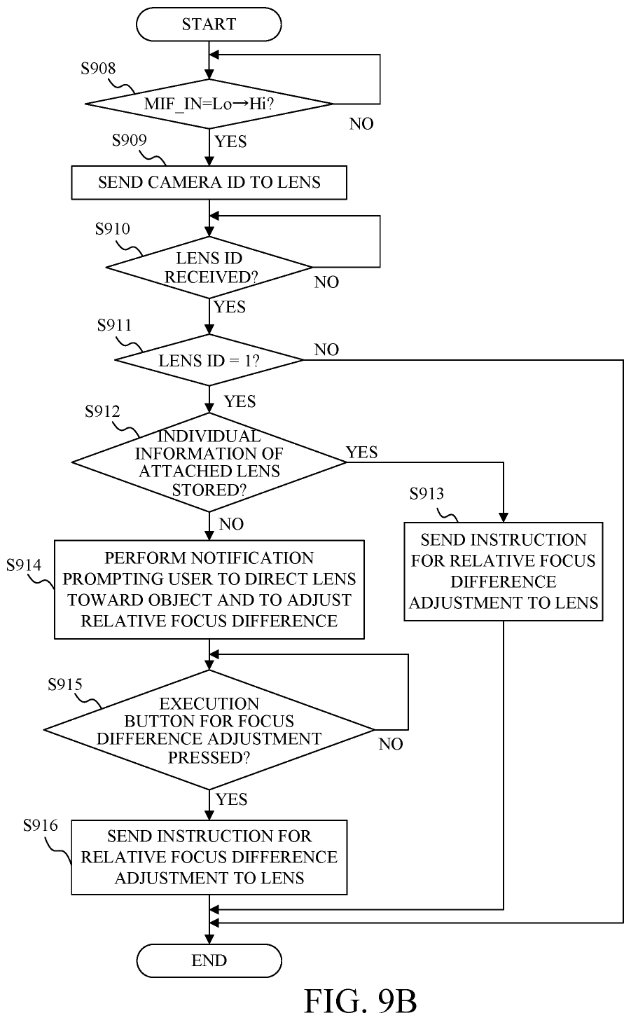

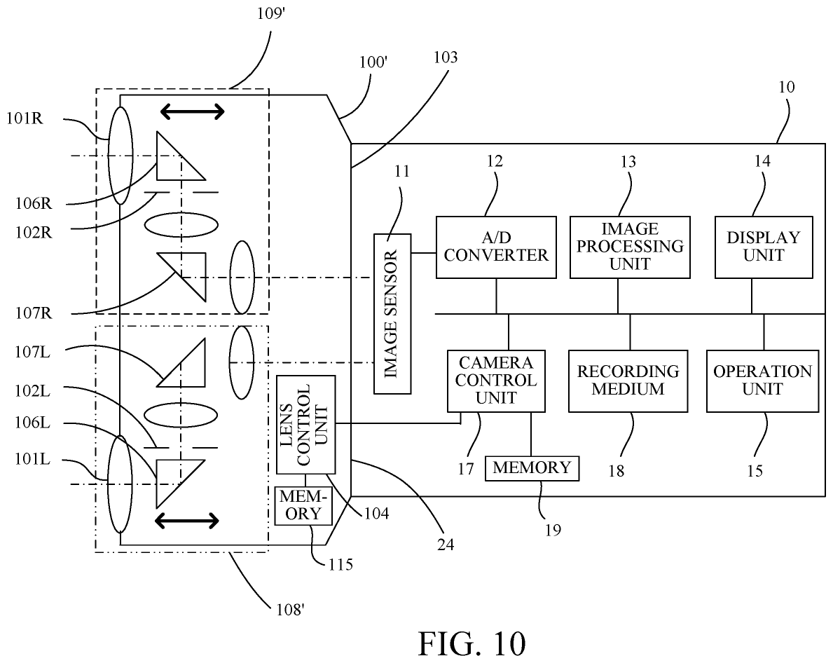

Flowcharts in FIGS. 9A and 9B show processing executed in this embodiment. FIG. 9A illustrates processing executed by the lens control unit 104 (the lens microcomputer 111) in accordance with a program, and FIG. 9B illustrates processing executed by the camera control unit 17 (the camera microcomputer 20) in accordance with a program.

When the interchangeable lens 100 is attached to the camera 10, the lens control unit 104 performs processes of the steps S901 to S903 in FIG. 9A. The processes of the steps S901 to S903 are the same as the processes of the steps S701 to S703 in FIG. 7A.

The lens control unit 104, which has received the instruction to adjust the relative focus difference in the step S903, determines in a step S904 whether or not the individual information about the camera 10 attached to the interchangeable lens 100 has been stored. The individual information about the camera 10 is included in the camera ID received in the step S901. In a case where the individual information about the camera 10 has been stored, the flow proceeds to a step S905. In a case where the individual information about the camera 10 has not been stored, the flow proceeds to a step S906.

In the step S905, the lens control unit 104 drives the focus difference adjustment driving unit 112 using the focus difference adjustment amount stored in association with the stored individual information about the camera 10 to perform the adjustment of the relative focus difference. Then, this processing ends.

In the step S906, the lens control unit 104 drives the focus difference adjustment driving unit 112 to perform the adjustment of the relative focus difference.

Next, in a step S907, the lens control unit 104 stores the focus difference adjustment amount in the step S906 in a memory (storage unit) 115 in the interchangeable lens 100 in association with the individual information about the camera 10. Then, this processing ends.

On the other hand, when the interchangeable lens 100 is attached to the camera 10, the camera control unit 17 performs processes of the steps S908 to S912 in FIG. 9B. The processes from the steps S908 to S912 are the same as the processes from the steps S808 to S812 in FIG. 8B.

The camera control unit 17, which has determined in the step S912 that the individual information about the attached interchangeable lens 100 has been stored in the camera 10, sends to the lens control unit 104 the instruction to adjust the relative focus difference in a step S913. Then, this processing ends.

The processes from steps S914 to S916 are the same as the processes from steps S814 to S816 in FIG. 8B. After the step S916, this processing ends.

In this embodiment, in a case where the adjustment of the relative focus difference has been performed in the past for a combination of the camera 10 and the interchangeable lens 100, when using the combination again, the focus difference adjustment amount stored in the interchangeable lens 100 is used to quickly adjust the relative focus difference.

In each of the above embodiments, the camera 10 having a single image sensor 11 has been described. However, an image pickup apparatus according to other embodiments may have one image sensor for each optical system (two image sensors in total) for two optical systems included in a stereoscopic lens apparatus.

Further, in each of the above embodiments, the case has been described in which the notification prompting the user to adjust the focus difference between two optical systems is provided, but information indicating a relative focus difference amount between the two optical systems may also be notified at the same time. For example, a difference between a defocus amount of the right eye optical system and a defocus amount of the left eye optical system calculated from an output of the image sensor may be calculated, and the information indicating the relative focus difference amount may be displayed based on the difference.

### SEVENTH EMBODIMENT

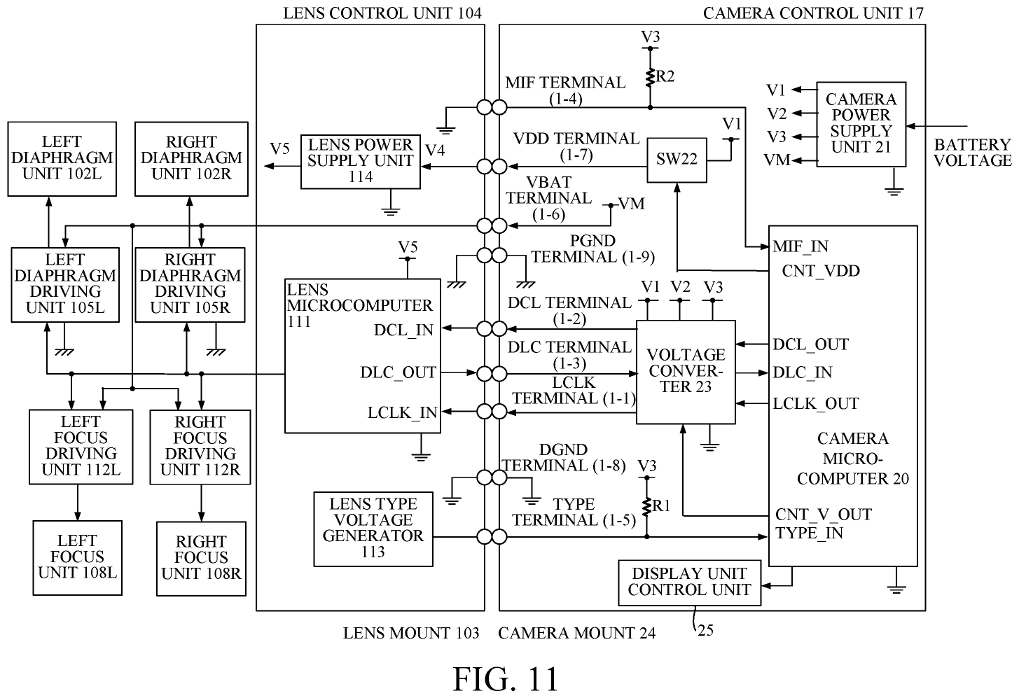

FIG. 10 illustrates a configuration of a stereoscopic camera system in which an interchangeable lens 100′ as a stereoscopic lens apparatus according to the seventh embodiment (and eighth to twelfth embodiments to be described later), is detachably attached to the camera 10. FIG. 11 illustrates an internal structure of the camera control unit 17 and the lens control unit 104, and a configuration of a diaphragm and focus drive system provided in the interchangeable lens 100′. In these figures, components common to those illustrated in FIGS. 1 and 2 are designated by the same reference numerals as those in FIGS. 1 and 2, and explanations thereof will be omitted.

The interchangeable lens 100′ according to this embodiment includes a right focus unit 108R which holds the right eye lens unit 101R and a left focus unit 108L which holds the left eye lens unit 101L. Furthermore, the interchangeable lens 100′ includes a right focus driving unit 112R that drives the right focus unit 108R in the optical axis direction (an object side and an image side) of the right eye lens unit 101R, and a left focus driving unit 112L that drives the left focus unit 108L in the optical axis direction of the left eye lens unit 101L. The right focus driving unit 112R and the left focus driving unit 112L, which have an actuator and can drive the right and left focus units 108R and 108L (the right eye and left eye lens units 101R and 101L) independently from each other.

In the first to sixth embodiments, the focus unit 108 holding the right eye and left eye lens units 101R and 101L is moved by the focus driving unit 110, and the whole of the right eye and left eye lens units 101R and 101L is moved as one unit to perform the focusing. On the other hand, in this embodiment and the eighth to twelfth embodiments described below, the right and left focus driving units 112R and 112L are operated simultaneously (synchronized) to simultaneously drive the right and left eye lens units 101R and 101L as one unit, which enables the focusing (focus drive) using the entire extension method.

By operating one of the right and left focus driving units 112R and 112L independently to drive the one of the right and left eye lens units 101R and 101L independently, focusing of the one lens unit, that is, an adjustment of the relative focus difference described below, can be performed.

Also, in the interchangeable lens 100′ according to this embodiment, when the image sensor 11 is inclined as illustrated in FIG. 3B, the right eye and left eye lens units 101R and 101L cannot be focused simultaneously, even if they are moved as one unit while maintaining the same positional relationship in the optical axis direction. That is, a relative focus difference occurs between the right eye and left eye lens units 101R and 101L as a shift in focus state. For this reason, the interchangeable lens 100′ according to this embodiment first has the user perform an operation to move a lens unit, among the right eye and left eye lens units 101R and 101L, that is out-of-focus with respect to the image sensor 11 to a position in the optical axis direction where it is in-focus with respect to the image sensor 11.

In the following explanation, moving the out-of-focus lens unit to the in-focus position is referred to as an adjustment of the relative focus difference. The adjustment of the relative focus difference is performed by the lens control unit 104 driving the corresponding focus driving unit in response to an operation by the user who has confirmed the focus status of the right eye image and left eye image. In this case, an offset is obtained from a drive amount of the focus driving unit. If one lens unit (e.g., the right eye lens unit 101R), among the right and left eye lens units 101R and 101L, to be moved in the adjustment of the relative focus difference is fixed in advance, it is easier for the user to perform the adjustment of the relative focus difference. Of course, the lens unit to be moved in the adjustment of the relative focus difference may be selectable by the user as appropriate.

When the adjustment of the relative focus difference is performed, an offset, which is information about the resulting positional difference in the optical axis direction between the right eye and left eye lens units 101R and 101L, is stored. Then, during the subsequent focusing, the right and left focus driving units 112R and 112L are controlled so as to move the right and left eye lens units 101R and 101L together while maintaining the offset. The focusing is performed by the lens control unit 104 controlling the right and left focus driving units 112R and 112L in response to a user's operation instructing the focusing or in response to an instruction of an autofocus (AF) including a focus drive amount from the camera 10.

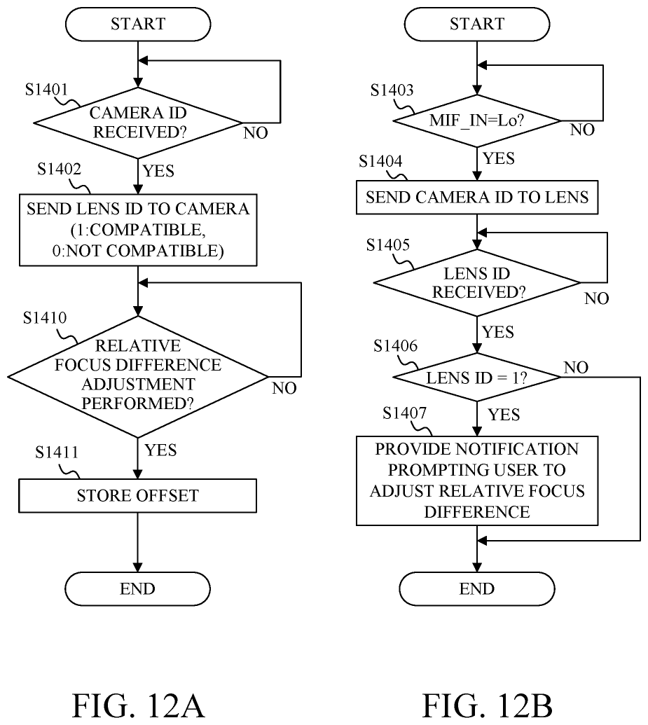

Flowcharts in FIGS. 12A and 12B show processing (control method) executed in this embodiment. FIG. 12A illustrates processing executed by the lens control unit 104 (the lens microcomputer 111) in accordance with a program, and FIG. 12B illustrates processing executed by the camera control unit 17 (the camera microcomputer 20) in accordance with a program.

When the interchangeable lens 100′ is attached to the camera 10, in a step S1401 of FIG. 12A, the lens control unit 104 serving as attachment detector on the lens side checks whether or not the camera ID has been received from the camera control unit 17 (whether or not the interchangeable lens 100′ has been attached to the camera 10). At this time, the lens control unit 104 checks from the camera ID whether or not the camera 10 has a function to perform the notification described below.

The lens control unit 104 that has received the camera ID proceeds to a step S1402, and sends to the camera control unit 17 the lens ID that indicates whether or not the interchangeable lens 100′ is a stereoscopic lens apparatus capable of adjusting the relative focus difference. The lens ID=1 indicates that the attached interchangeable lens is a stereoscopic lens apparatus capable of adjusting the relative focus difference (in other words, independent focusing of one lens unit), acquiring and storing an offset, described later, caused by the adjustment of the relative focus difference, and performing the focusing using this offset. The lens ID=0 indicates that the attached interchangeable lens is not a stereoscopic lens apparatus capable of adjusting the relative focus difference or storing the offset. Then, the flow proceeds to a step S1410.

On the other hand, when the interchangeable lens 100′ is attached to the camera 10, in a step S1403 of FIG. 12B, the camera control unit 17 as attachment detector on the camera side determines whether or not MIF_IN=Lo, that is, whether or not the interchangeable lens 100′ has been attached to the camera 10. In a case where MIF_IN≠ Lo, the camera control unit 17 repeats the determination in the step S1403, and in a case where MIF_IN=Lo, the camera control unit 17 sends the camera ID to the lens control unit 104 in a step S1404, and proceeds to a step S1405.

In the step S1405, the camera control unit 17 determines whether or not the lens ID has been received. The camera control unit 17 repeats the determination in step the S1405 in a case where the lens ID has not been received, and proceeds to a step S1406 in a case where the lens ID has been received.

In the step S1406, the camera control unit 17 determines whether or not the lens ID=1. The camera control unit 17 ends this processing in a case where the lens ID=0, and proceeds to a step S1407 in a case where the lens ID=1.

In the step S1407, the camera control unit 17 provides the notification prompting the user to adjust the relative focus difference. Specifically, a message or an icon prompting the user to adjust the relative focus difference is displayed on the display unit 14 through the display unit control unit 25. The message is, for example, “Please perform the focusing of the right eye lens.” The notification prompting the user to adjust the relative focus difference may be made by sound from a speaker (not illustrated).

The lens control unit 104, which has proceeded to the step S1410, determines whether or not the adjustment of the relative focus difference has been performed by the user. In a case where the adjustment of the relative focus difference has been performed, the flow proceeds to a step S1411, and in a case where the adjustment of the relative focus difference has not been performed, the determination in the step S1410 is repeated.

In the step S1411, the lens control unit 104 acquires the offset in the adjustment of the relative focus difference, and stores (saves) this in the memory (storage unit) 115 provided in the interchangeable lens 100′ illustrated in FIG. 10. Then, this processing ends.

According to this embodiment, the user can be prompted to adjust the relative focus difference in response to the attachment of the interchangeable lens 100′ to the camera 10. Then, the focusing can be performed by integrally moving the right eye and left eye lens units 101R and 101L while the offset stored by the adjustment of the relative focus difference is maintained.

### EIGHTH EMBODIMENT

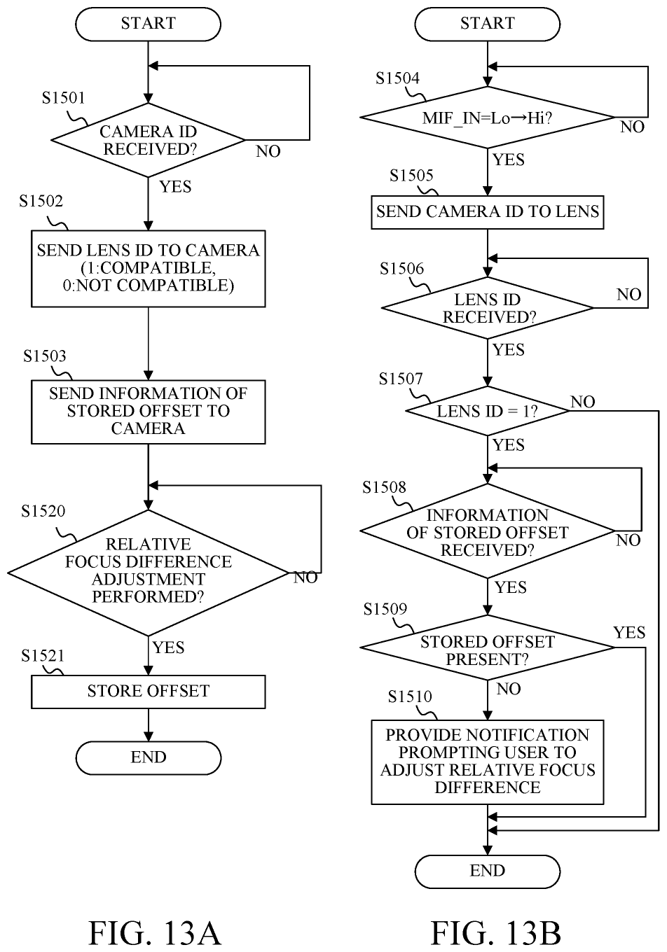

In the eighth embodiment, only in a case where the adjustment of the relative focus difference has not been performed when the interchangeable lens 100′ was attached to the camera 10 in the past, the notification prompting the user to adjust the relative focus difference is provided. Flowcharts in FIGS. 13A and 13B show processing executed in this embodiment. FIG. 13A illustrates processing executed by the lens control unit 104 (the lens microcomputer 111) in accordance with a program, and FIG. 13B illustrates processing executed by the camera control unit 17 (the camera microcomputer 20) in accordance with a program.

When the interchangeable lens 100′ is attached to the camera 10, the lens control unit 104 performs processes of a step S1501 and a step S1502 in FIG. 13A. The processes of the step S1501 and the step S1502 are the same as the processes of the step S1401 and the step S1402 in FIG. 12A.

In a step S1503 after the step S1502, the lens control unit 104 sends to the camera control unit 17 information on the presence or absence of the offset stored by the adjustment of the relative focus difference when the interchangeable lens 100′ was attached to the camera 10 in the past (in other words, implementation history of the adjustment of the relative focus difference). Then, the flow proceeds to a step S1520.

On the other hand, when the interchangeable lens 100′ is attached to the camera 10, the camera control unit 17 performs processes of steps S1504 to S1507 in FIG. 13A. The processes of the steps S1504 to S1507 are the same as the processes of the steps S1403 to S1406 in FIG. 12B.

In a case where the lens ID=1 in the step S1507, the camera control unit 17 determines whether or not the information on the presence or absence of the stored offset has been received from the lens control unit 104 in a step S1508. In a case where the camera control unit 17 has not received the information on the presence or absence of the stored offset, the camera control unit 17 repeats the determination in the step S1508, and in a case where the camera control unit 17 has received the information, the camera control unit 17 proceeds to a step S1509.

In the step S1509, the camera control unit 17 determines whether or not the information received in the step S1508 indicates that the stored offset is “present”, that is, whether or not the adjustment of the relative focus difference has been performed in the past for the currently attached interchangeable lens 100′. In a case where the information indicates that the stored offset is “absent”, the flow proceeds to a step S1510, and in a case where the information indicates that the stored offset is “present”, this processing ends.

In the step S1510, the camera control unit 17 performs the notification (display) prompting the user to adjust the relative focus difference, similarly to the step S1407 in FIG. 12B. Then, this processing ends.

The lens control unit 104, which has proceeded to the step S1520, determines whether or not the adjustment of the relative focus difference has been performed by the user. In a case where the adjustment of the relative focus difference has been performed, the flow proceeds to a step S1521, and in a case where the adjustment of the relative focus difference has not been performed, the determination in the step S1520 is repeated.

In the step S1521, the lens control unit 104 acquires the offset in the adjustment of the relative focus difference, and stores this in the memory 115. Then, this processing ends.

In this embodiment, the user can be prompted to adjust the relative focus difference in a combination of the interchangeable lens 100′ and the camera 10 for which the adjustment of the relative focus difference has been performed in the past and the offset has not been stored.

### NINTH EMBODIMENT

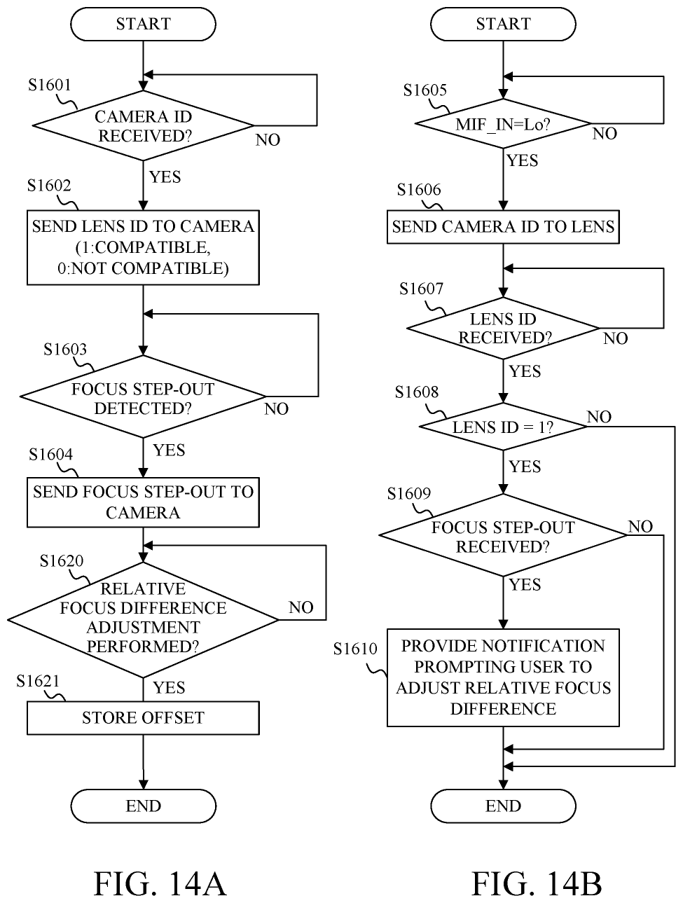

In the ninth embodiment, when an external force is applied to at least one of the right eye and left eye lens units 101R and 101L (the right and left focus units 108R and 108L), the notification prompting the user to adjust the relative focus difference is provided. Flowcharts in FIGS. 14A and 14B show processing executed in this embodiment. FIG. 14A illustrates processing executed by the lens control unit 104 (the lens microcomputer 111) in accordance with a program, and FIG. 14B illustrates processing executed by the camera control unit 17 (the camera microcomputer 20) in accordance with a program. In this embodiment, in response to detecting a step-out of a stepping motor of either the right focus driving unit 112R or the left focus driving unit 112L due to an action of the external force, the notification prompting the user to adjust the relative focus difference is provided.

When the interchangeable lens 100′ is attached to the camera 10, the lens control unit 104 performs processes of a step S1601 and a step S1602 in FIG. 14A. The processes of the step S1601 and the step S1602 are the same as the processes of the step S1401 and the step S1402 in FIG. 12A.

In a step S1603 after the step S1602, the lens control unit 104 determines whether or not the step-out has occurred in the stepping motor of either the right focus driving unit 112R or the left focus driving unit 112L. Specifically, light-shielding blades are attached to a rotary shaft of each stepping motor, and the light-shielding blades and photo interrupters are used to detect whether or not each stepping motor rotates at a timing other than during the integrated left and right focus driving or during the adjustment of the relative focus difference. By detecting a rotation of each stepping motor, it is possible to determine that the step-out has occurred, in other words, that the either right focus unit 108R or the left focus unit 108L has received the external force. External force detector is constituted by the light-shielding blades and the photo interrupters.

Instead of the light-shielding blades and the photo interrupters, an external force sensor that can directly detect an action of an external force may be used, and in a case where the action of the external force of a predetermined magnitude or more is detected, it may be assumed that the step-out has occurred in the stepping motor. In a case where the lens control unit 104 does not determine that the step-out (hereinafter referred to as focus step-out) has occurred in the stepping motor of the right focus driving unit 112R or the left focus driving unit 112L, the lens control unit 104 repeats the process of the step S1603. In a case where the lens control unit 104 determines that the focus step-out has occurred in the stepping motor of the right focus driving unit 112R or the left focus driving unit 112L, the lens control unit 104 proceeds to a step S1604.

In the step S1604, the lens control unit 104 sends to the camera control unit 17 that the focus step-out has occurred. Then, the flow proceeds to a step S1620.

On the other hand, when the interchangeable lens 100′ is attached to the camera 10, the camera control unit 17 performs processes of steps S1605 to S1608 in FIG. 14B. The processes of the steps S1605 to S1608 are the same as the processes of the steps S1403 to S1406 in FIG. 12B.

In a case where the lens ID=1 in the step S1608, the camera control unit 17 determines whether or not the occurrence of the focus step-out has been received from the lens control unit 104 in a step S1609. In a case where the camera control unit 17 has not received the occurrence of the focus step-out, the camera control unit 17 repeats the process of the step S1608, and in a case where the camera control unit 17 has received the occurrence of the focus step-out, the camera control unit 17 proceeds to a step S1610.

In the step S1610, the camera control unit 17 performs the notification (display) prompting the user to adjust the relative focus difference, similarly to the step S407 in FIG. 12B. Then, this processing ends.

The lens control unit 104, which has proceeded to the step S1620, determines whether or not the adjustment of the relative focus difference has been performed by the user. In a case where the adjustment of the relative focus difference has been performed, the flow proceeds to a step S1621, and in a case where the adjustment of the relative focus difference has not been performed, the determination in the step S1620 is repeated.

In the step S1621, the lens control unit 104 acquires the offset in the adjustment of the relative focus difference, and stores this in the memory 115. Then, this processing ends.

In this embodiment, when the relative focus difference occurs due to the action of the external force, the user can be prompted to adjust the relative focus difference.

### TENTH EMBODIMENT

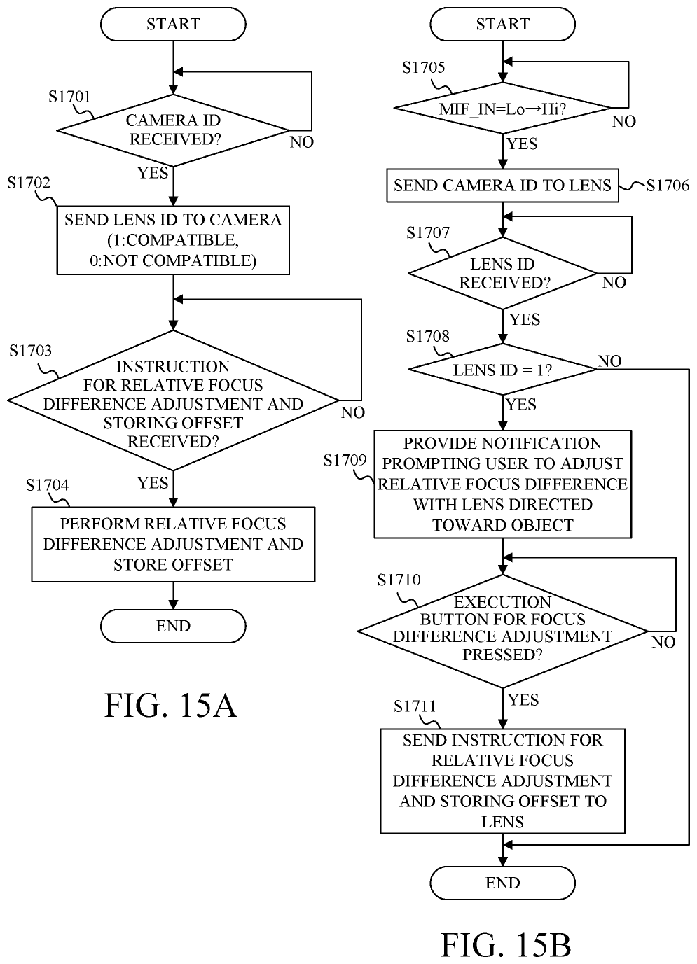

In the tenth embodiment, the notification is provided to prompt the user to point the interchangeable lens 100′ at the object and then adjust the relative focus difference. Flowcharts in FIGS. 15A and 15B show processing executed in this embodiment. FIG. 15A illustrates processing executed by the lens control unit 104 (the lens microcomputer 111) in accordance with a program, and FIG. 15B illustrates processing executed by the camera control unit 17 (the camera microcomputer 20) in accordance with a program.

When the interchangeable lens 100′ is attached to the camera 10, the lens control unit 104 performs processes of a step S1701 and a step S1702 in FIG. 15A. The processes of the step S1701 and the step S1702 are the same as the processes of the step S1401 and the step S1402 in FIG. 12A. After the step S1702, the lens control unit 104 proceeds to a step S1703.

On the other hand, when the interchangeable lens 100′ is attached to the camera 10, the camera control unit 17 performs processes of steps S1705 to S1708 in FIG. 15B. The processes of the steps S1705 to S1708 are the same as the processes of the steps S1403 to S1406 in FIG. 12B.

In a case where the lens ID=1 in the step S1708, the camera control unit 17 performs the notification (display) in a step S1709 prompting the user to point the interchangeable lens 100′ at the object and perform the adjustment of the relative focus difference. Specifically, a message or an icon is displayed on the display unit 14 of the camera 10 to prompt the user to point the interchangeable lens 100′ at the object and adjust the relative focus difference. The message may be, “Please point the lens at the object and press the button for the adjustment of the focus difference.”

Next, in a step S1710, the camera control unit 17 determines whether or not the user has operated the execution button for the adjustment of the focus difference. In a case where the execution button for the adjustment of the focus difference has not been operated, the determination in the step S1710 is repeated, and in a case where the execution button for the adjustment of the focus difference has been operated, the camera control unit 17 proceeds to a step S1711.

In the step S1711, the camera control unit 17 sends the instruction for the adjustment of the relative focus difference to the lens control unit 104. Then, this processing ends.

The lens control unit 104, which has proceeded to the step S1703, determines whether or not the instruction for the adjustment of the relative focus difference has been received from the camera control unit 17. The instruction for the adjustment of the relative focus difference is sent from the camera control unit 17 to the lens control unit 104 when the user operates the execution button for the adjustment of the focus difference (not illustrated) provided on the operation unit 15 of the camera 10. The execution button for the adjustment of the focus difference may be a physical button or may be provided on a touch panel of the display unit 14. In a case where the lens control unit 104 has not received the instruction, the lens control unit 104 repeats the determination in the step S1703, and in a case where the lens control unit 104 has received the instruction, the lens control unit 104 proceeds to a step S1704.

In the step S1704, the lens control unit 104 performs the adjustment of the relative focus difference by controlling the focus driving unit corresponding to one of the right and left focus driving unit 112R and 112L to be moved during the adjustment of the relative focus difference. Furthermore, the offset in the adjustment of the relative focus difference is acquired and stored in the memory 115. Then, this processing ends.

According to this embodiment, not only can the user be prompted to adjust the relative focus difference, but also it is possible to notify the user that the interchangeable lens 100′ needs to be directed toward the object when adjusting the relative focus difference. This makes it possible to reliably adjust the relative focus difference for the object.

### ELEVENTH EMBODIMENT

In the eleventh embodiment, a case will be described in which the camera 10 is capable of storing an offset for each individual interchangeable lens 100′. In this embodiment, when the interchangeable lens 100′ whose offset is stored in the camera 10 is attached to the camera 10, the integrated focus driving of the right eye and left eye lens units 101R and 101L using the stored offset is enabled.

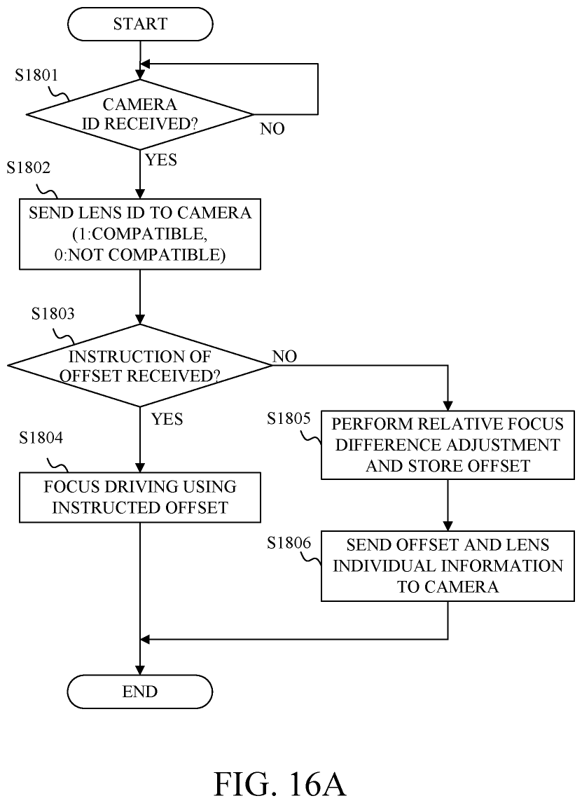

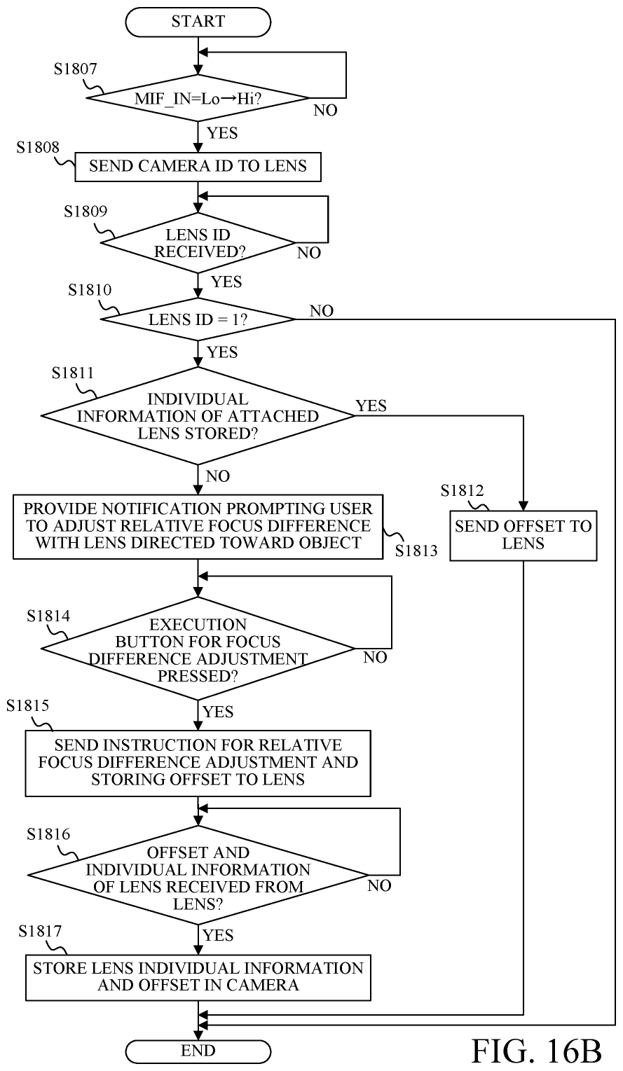

Flowcharts in FIGS. 16A and 16B show processing executed in this embodiment. FIG. 16A illustrates processing executed by the lens control unit 104 (the lens microcomputer 111) in accordance with a program, and FIG. 16B illustrates processing executed by the camera control unit 17 (the camera microcomputer 20) in accordance with a program.

When the interchangeable lens 100′ is attached to the camera 10, the lens control unit 104 performs processes of a step S1801 and a step S1802 in FIG. 16A. The processes of the step S1801 and the step S1802 are the same as the processes of the step S1701 and the step S1702 in FIG. 15A.

In a step S1803 after the step S1802, the lens control unit 104 determines whether or not an instruction of an offset in a relative offset adjustment has been received from the camera control unit 17. In a case where the instruction has been received, the flow proceeds to a step S1804. In a case where the instruction has not been received, the flow proceeds to a step S1805.

In the step S1804, the lens control unit 104 allows the integrated focus driving (focusing) of the right eye and left eye lens units 101R and 101L so as to maintain the instructed offset. Then, this processing ends.

Further, in a step S1805, the lens control unit 104 performs the adjustment of the relative focus difference to acquire an offset, and stores the offset in the memory 115.

Then, in a step S1806, the lens control unit 104 sends the offset stored in the step S1805 to the camera control unit 17 together with the individual information (manufacturing number, serial number, etc.) of the interchangeable lens 100′. Then, this processing ends. The camera control unit 17 stores (saves) the offset in the memory (storage unit) 19 in the camera 10 in association with the received individual information about the interchangeable lens 100′, as will be described later.

On the other hand, when the interchangeable lens 100′ is attached to the camera 10, the camera control unit 17 performs processes of steps S1807 to S1810 in FIG. 16B. The processes of the steps S1807 to S1810 are the same as the processes of the steps S1705 to S1708 in FIG. 15B.

In a case where the lens ID=1 in the step S1810, the camera control unit 17 determines in a step S1811 whether or not the individual information about the attached interchangeable lens 100′ has been stored in the memory 19 in the camera 10. In a case where the individual information has been stored, the flow proceeds to a step S1812. In a case where the individual information has not been stored, the flow proceeds to a step S1813.

In the step S1812, the camera control unit 17 sends to the lens control unit 104 the offset stored in association with the stored individual information about the interchangeable lens 100′.

The processes from steps S1813 to S1815 are the same as the processes from the steps S1709 to S1711 in FIG. 15B.

In a step S1816 after the step S1815, the camera control unit 17 determines whether or not the individual information about the interchangeable lens 100′ and offset have been received from the lens control unit 104. In a case where these have not been received, the determination in the step S1816 is repeated. In a case where these have been received, the flow proceeds to a step S1818.

In a step S1817, the camera control unit 17 stores the offset in the memory 19 in the camera 10 in association with the received individual information about the interchangeable lens 100′. Then, this process ends.

In this embodiment, in a case where the adjustment of the relative focus difference has been performed in the past for the combination of the camera 10 and the interchangeable lens 100′, when the combination is used again, the focus driving can be performed quickly using the offset stored in the camera 10 without performing the adjustment of the relative focus difference.

### TWELFTH EMBODIMENT

In the twelfth embodiment, a case will be described in which the interchangeable lens 100′ is capable of storing an offset for each individual camera 10. In this embodiment, in a case where the offset for the camera 10 to which the interchangeable lens 100′ is attached is stored in the interchangeable lens 100′, the integrated focus driving of the right eye and left eye lens units 101R and 101L using the stored offset is enabled.

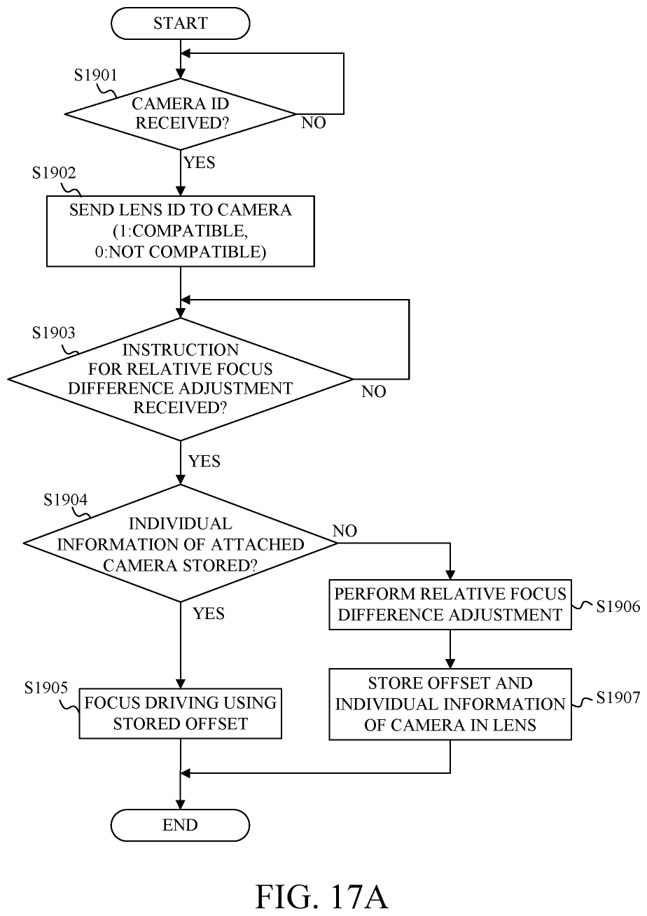

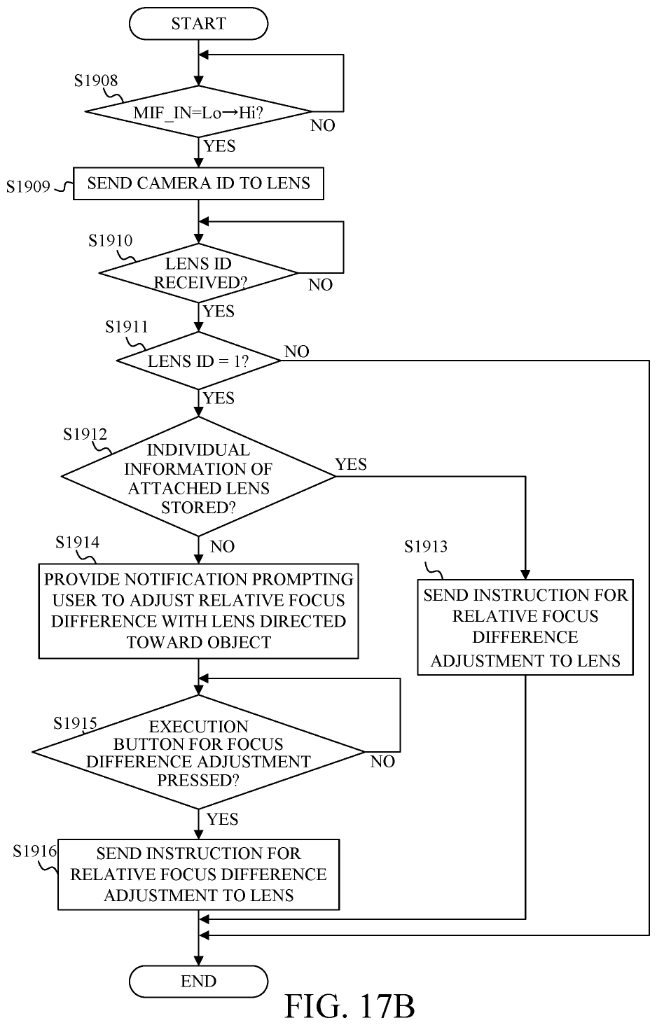

Flowcharts in FIGS. 17A and 17B show processing executed in this embodiment. FIG. 17A illustrates processing executed by the lens control unit 104 (the lens microcomputer 111) in accordance with a program, and FIG. 17B illustrates processing executed by the camera control unit 17 (the camera microcomputer 20) in accordance with a program.

When the interchangeable lens 100′ is attached to the camera 10, the lens control unit 104 performs processes of a step S1901 and a step S1902 in FIG. 17A. The processes of the step S1901 and the S1902 are the same as the processes of the step S1701 and the S1702 in FIG. 15A.

In a step S1903 after the step S1902, the lens control unit 104 determines whether or not an instruction for the relative offset adjustment has been received from the camera control unit 17. In a case where the instruction has been received, the flow proceeds to a step S1904. In a case where the instruction has not been received, the determination in the step S1903 is repeated.

In the step S1904, the lens control unit 104 determines whether or not the individual information about the camera 10 to which the interchangeable lens 100′ is attached has been stored. The individual information about the camera 10 is included in the camera ID received in the step S1901. In a case where the individual information about the camera 10 has been stored, the flow proceeds to a step S1905, and in a case where the individual information has not been stored, the flow proceeds to a step S1906.

In the step S1905, the lens control unit 104 allows the integrated focus driving (focusing) of the right eye and left eye lens units 101R and 101L so as to maintain the offset stored in association with the stored individual information about the camera 10. Then, this processing ends.

Further, in the step S1906, the lens control unit 104 performs the adjustment of the relative focus difference.

Next, in a step S1907, the lens control unit 104 stores the offset obtained by the adjustment of the relative focus difference in the step S1906 in the memory 115 in association with the individual information about the camera 10. Then, this processing ends.

On the other hand, when the interchangeable lens 100′ is attached to the camera 10, the camera control unit 17 performs processes of steps S1908 to S1912 in FIG. 17B. The processes of the steps S1908 to S1912 are the same as the processes of the steps S1807 to S1811 in FIG. 16B.

The camera control unit 17, which has determined in the step S1912 that the individual information about the attached interchangeable lens 100′ has been stored in the camera 10, sends to the lens control unit 104 the instruction to adjust the relative focus difference in a step S1913. Then, this processing ends.

The camera control unit 17, which has determined in the step S1912 that the individual information about the attached interchangeable lens 100′ has not been stored in the camera 10, performs processes of steps S1914 to S1916. The processes of the step S1914 to step S1916 are the same as the processes of the step S1813 to step S1815 in FIG. 16B. After the step S1916, this processing ends.

In this embodiment, in a case where the adjustment of the relative focus difference has been performed in the past for the combination of the camera 10 and the interchangeable lens 100′, when the combination is used again, the focus driving can be performed quickly using the offset stored in the interchangeable lens 100′ without performing the adjustment of the relative focus difference.

As described at the end of the sixth embodiment, one image sensor may be provided for each of the two optical systems included in the stereoscopic lens apparatus (two image sensors in total). Further, in addition to the notification prompting the user to adjust the relative focus difference between the two optical systems, information indicating the amount of the focus difference between the two optical systems may also be notified.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-206350 filed on Dec. 23, 2022, and Japanese Patent Application No. 2023-048980 filed on Mar. 24, 2023, which are hereby incorporated by reference herein in their entirety.

What is claimed is:

1. An image pickup apparatus attachable to, detachable from, and communicable with a stereoscopic lens apparatus that includes two optical systems arranged in parallel, a focusing unit configured to perform focusing that integrally moves the two optical systems, and a focus difference adjustment unit configured to perform focus difference adjustment for adjusting a focus difference between the two optical systems by independently moving one optical system of the two optical systems, the image pickup apparatus comprising:
a memory storing instructions; and
a processor configured to execute the instructions to:
detect an attachment of the stereoscopic lens apparatus to the image pickup apparatus, and
provide a notification prompting a user to perform the focus difference adjustment with the stereoscopic lens apparatus attached to the image pickup apparatus.

2. The image pickup apparatus according to claim 1, wherein the processor is configured to provide the notification in response to receiving from the stereoscopic lens apparatus information indicating that the focus difference adjustment can be performed in the stereoscopic lens apparatus.

3. The image pickup apparatus according to claim 1, wherein the processor is configured to provide the notification in a case where information indicating that the focus difference adjustment has not been performed in a combination of the stereoscopic lens apparatus and the image pickup apparatus is received from the stereoscopic lens apparatus.

4. The image pickup apparatus according to claim 1, wherein the processor is configured to provide the notification in a case where information indicating that an externa force is applied to the stereoscopic lens apparatus is received from the stereoscopic lens apparatus.

5. The image pickup apparatus according to claim 1, wherein the processor is configured to provide, as the notification, a notification prompting the user to direct the stereoscopic lens apparatus toward an object.

6. The image pickup apparatus according to claim 1, further comprising an operation unit operated by a user who instructs the focus difference adjustment,
wherein the processor is configured to transmit to the stereoscopic lens apparatus an instruction to perform the focus difference adjustment in response to an operation of the operation unit.

7. The image pickup apparatus according to claim 1, wherein the processor is configured to:
store in the memory information on the focus difference adjustment in a case where the processor has received from the stereoscopic lens apparatus the information on the focus difference adjustment that has been performed in a combination of the stereoscopic lens apparatus and the image pickup apparatus, and
transmit to the stereoscopic lens apparatus the information on the focus difference adjustment stored in the memory in a case where the stereoscopic lens apparatus in the combination is again attached to the image pickup apparatus.

8. The image pickup apparatus according to claim 1, wherein in a case where information on the focus difference adjustment that has been performed in a combination of the stereoscopic lens apparatus and the image pickup apparatus is stored in the stereoscopic lens apparatus, when the stereoscopic lens apparatus in the combination is attached to the image pickup apparatus, the processor is configured to instruct the stereoscopic lens apparatus to perform the focus difference adjustment based on the stored information on the focus difference adjustment.

9. The image pickup apparatus according to claim 1, wherein the processor is configured to acquire information about a positional difference between the two optical systems caused by the focus difference adjustment of the stereoscopic lens apparatus, and provides the notification in a case where the focusing can be performed using the information about the positional difference.

10. The image pickup apparatus according to claim 9, wherein the processor is configured to:
store in the memory the information about the positional difference between the two optical systems in a case where the processor has received from the stereoscopic lens apparatus the information about the positional difference acquired by the focus difference adjustment that has been performed in a combination of the stereoscopic lens apparatus and the image pickup apparatus, and
transmit to the stereoscopic lens apparatus the information about the positional difference stored in the memory in a case where the stereoscopic lens apparatus in the combination is again attached to the image pickup apparatus.

11. The image pickup apparatus according to claim 9, wherein in a case where the information about the positional difference between the two optical systems acquired by the focus difference adjustment that has been performed in a combination of the stereoscopic lens apparatus and the image pickup apparatus is stored in the stereoscopic lens apparatus, when the stereoscopic lens apparatus in the combination is attached to the image pickup apparatus, the processor is configured to instruct the stereoscopic lens apparatus to perform the focusing using the stored information about the positional difference.

12. A stereoscopic lens apparatus attachable to, detachable from, and communicable with an image pickup apparatus, the stereoscopic lens apparatus comprising:
two optical systems arranged in parallel;
a focusing unit configured to perform focusing that integrally moves the two optical systems;
a focus difference adjustment unit configured to perform focus difference adjustment for adjusting a focus difference between the two optical systems by independently moving one optical system of the two optical systems;
a memory storing instructions; and
a processor configured to execute the instructions to:
detect an attachment of the stereoscopic lens apparatus to the image pickup apparatus, and
transmit to the image pickup apparatus information indicating that the focus difference adjustment can be performed in a case where the stereoscopic lens apparatus is attached to the image pickup apparatus capable of providing a notification prompting a user to perform the focus difference adjustment.

13. The stereoscopic lens apparatus according to claim 12, wherein the processor is configured to transmit information indicating whether or not the focus difference adjustment has been performed to the image pickup apparatus that provides the notification in a case where the focus difference adjustment has not been performed in a combination on the stereoscopic lens apparatus and the image pickup apparatus.

14. The stereoscopic lens apparatus according to claim 12, further comprising an external force detector configured to detect that an external force is applied to the stereoscopic lens apparatus,
wherein the processor is configured to transmit information indicating that it is detected that the external force is applied to the stereoscopic lens apparatus to the image pickup apparatus which provides the notification in a case where the external force is applied to the stereoscopic lens apparatus.

15. The stereoscopic lens apparatus according to claim 12, wherein the processor is configured to perform the focus difference adjustment according to receiving an instruction to perform the focus difference adjustment from the image pickup apparatus.

16. The stereoscopic lens apparatus according to claim 12, wherein the processor is configured to:
transmit to the image pickup apparatus information on the focus difference adjustment that has been performed in a combination of the stereoscopic lens apparatus and the image pickup apparatus, and
perform the focus difference adjustment based on the information on the focus difference adjustment in a case where the stored information on the focus difference adjustment is received from the image pickup apparatus in the combination.

17. The stereoscopic lens apparatus according to claim 12, wherein the memory stores information on the focus difference adjustment that has been performed in a combination of the stereoscopic lens apparatus and the image pickup apparatus, and
wherein the processor is configured to perform the focus difference adjustment based on the stored information on the focus difference adjustment in a case where the stereoscopic lens apparatus is attached to the image pickup apparatus in the combination.

18. The stereoscopic lens apparatus according to claim 12, further comprising two driving units configured to drive the two optical systems independently from each other, and to perform the focusing that integrally moves the two optical systems and the focus difference adjustment that independently moves one optical system of the two optical systems.

19. The stereoscopic lens apparatus according to claim 18, wherein the processor is configured to acquire information about a positional difference between the two optical systems caused by the focus difference adjustment, and controls the two driving units using the information about the positional difference during the focusing.

20. The stereoscopic lens apparatus according to claim 19, wherein the processor is configured to:
transmit to the image pickup apparatus the information about the positional difference between the two optical systems acquired by the focus difference adjustment that has been performed in a combination of the stereoscopic lens apparatus and the image pickup apparatus, and
control the two driving units using the information about the positional difference during the focusing in a case where the information about the positional difference stored in the image pickup apparatus is received from the image pickup apparatus in the combination.

21. The stereoscopic lens apparatus according to claim 19, wherein the memory stores the information about a positional difference between the two optical systems acquired by the focus difference adjustment that has been performed in a combination of the stereoscopic lens apparatus and the image pickup apparatus,
wherein the processor is configured to controls the two driving units using the stored information about the positional difference during the focusing in a case where the stereoscopic lens apparatus is attached to the image pickup apparatus in the combination.

22. A control method of an image pickup apparatus attachable to, detachable from, and communicable with a stereoscopic lens apparatus including two optical systems arranged in parallel, a focusing unit configured to perform focusing that integrally moves the two optical systems, and a focus difference adjustment unit configured to perform focus difference adjustment for adjusting a focus difference between the two optical systems by independently moving one optical system of the two optical systems, the control method comprising the steps of:
detecting an attachment of the stereoscopic lens apparatus to the image pickup apparatus; and
providing a notification prompting a user to perform the focus difference adjustment with the stereoscopic lens apparatus attached to the image pickup apparatus.

23. A control method of a stereoscopic lens apparatus including two optical systems arranged in parallel and attachable to, detachable from, and communicable with an image pickup apparatus, the stereoscopic lens apparatus including a focusing unit configured to perform focusing that integrally moves the two optical systems, and a focus difference adjustment unit configured to perform focus difference adjustment for adjusting a focus difference between the two optical systems by independently moving one optical system of the two optical systems, the control method comprising the steps of:
detecting an attachment of the stereoscopic lens apparatus to the image pickup apparatus; and
transmitting to the image pickup apparatus information indicating that the focus difference adjustment can be performed in a case where the stereoscopic lens apparatus is attached to the image pickup apparatus capable of providing a notification prompting a user to perform the focus difference adjustment.

24. A non-transitory computer-readable storage medium for storing a computer program to cause a computer in the image pickup apparatus to execute the control method according to claim 22.

25. A non-transitory computer-readable storage medium for storing a computer program to cause a computer in the stereoscopic lens apparatus to execute the control method according to claim 23.
